(19) United States
(12) Patent Application Publication
(10) Pub. No.: US 2018/0157395 A1
(43) Pub. Date: Jun. 7, 2018

(54) MOBILE TERMINAL AND METHOD FOR CONTROLLING THE SAME

(71) Applicant: LG ELECTRONICS INC., Seoul (KR)

(72) Inventors: Yunjueng MHUN, Seoul (KR); Jihye YU, Seoul (KR); Younhwa CHOI, Seoul (KR); Yoojin CHOI, Seoul (KR); Huran CHOI, Seoul (KR); Jinhee LEE, Seoul (KR)

(73) Assignee: LG ELECTRONICS INC., Seoul (KR)

(21) Appl. No.: 15/673,007

(22) Filed: Aug. 9, 2017

(30) Foreign Application Priority Data
Dec. 7, 2016 (KR) 10-2016-0165557
Dec. 7, 2016 (KR) 10-2016-0165558

(51) Int. Cl. G06F 3/0481; G06F 3/0488; G06K 9/00

(52) U.S. Cl. CPC G06F 3/04812; G06K 9/00006; G06F 3/04817; G06F 3/0488

(57) ABSTRACT

A mobile terminal including a touch screen; and a processor configured to display a virtual home button on the touch screen, and change a shape of the virtual home button to represent a first event on the mobile terminal.

Pursuant to 35 U.S.C. § 119(a), this application claims the benefit of earlier filing date and right of priority to Korean Application Nos. 10-2016-0165557 and 10-2016-0165558 filed on Dec. 7, 2016, the contents of which are hereby incorporated by reference herein in its entirety.

### BACKGROUND OF THE INVENTION

### Field of the Invention

The present invention relates to a mobile terminal and method for controlling the same, and more particularly, to a mobile terminal for changing and displaying a virtual home button based on various input signals or events without a physical home button and method for controlling the same.

### Discussion of the Related Art

Terminals can be generally classified as mobile/portable terminals or stationary terminals. Mobile terminals can also be classified as handheld terminals or vehicle mounted terminals.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components.

In addition, mobile terminals without physical home buttons have been developed in recent years. Such a mobile terminal not only has a thin thickness but also allows a user to use a wide display unit. However, although the mobile terminal can display a virtual home button on the display unit, a technique for changing the virtual home button in various ways depending on situations of the mobile terminal has not been developed yet.

### SUMMARY OF THE INVENTION

Accordingly, an object of the present invention is to address the above-noted and other problems.

Another object of the present invention is to provide a mobile terminal for displaying a virtual home button on a display unit and changing a shape of the virtual home button when detecting an event and method for controlling the same.

It will be appreciated by persons skilled in the art that the objects that could be achieved with the present invention are not limited to what has been particularly described hereinabove and the above and other objects that the present invention could achieve will be more clearly understood from the following detailed description.

To achieve these objects and other advantages and in accordance with the purpose of the invention, as embodied and broadly described herein, a mobile terminal according to an embodiment of the present invention includes a sensing unit, a display unit, and a processor. The processor can display a virtual home button on the display unit and a shape of the virtual home button may be changed based on a first event.

Accordingly, a mobile terminal and method for controlling the same according to an embodiment of the present invention provide the following advantages.

According to at least one embodiment of the present invention, a mobile terminal can change a shape of a virtual home button based on at least one of a movement of the mobile terminal, reception of an event, and a displayed content instead of using a fixed home button, thereby allowing a user to easily use the virtual home button in accordance with the current situation.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1A is a block diagram of a mobile terminal according to an embodiment of the present disclosure;

FIGS. 1B and 1C are conceptual views of one example of the mobile terminal, viewed from different directions;

FIG. 2 is a conceptual view of a deformable mobile terminal according to an alternative embodiment of the present disclosure;

FIG. 3 is a perspective view illustrating an example of a watch-type mobile terminal according to an embodiment of the present invention;

FIG. 4 is a diagram illustrating configuration modules of a mobile terminal according to one embodiment of the present invention;

FIG. 5 is a diagram illustrating an example in which the mobile terminal changes a size of a virtual home button depending on a movement of the mobile terminal according to one embodiment of the present invention;

FIG. 6 is a diagram illustrating an example in which the mobile terminal displays a notification icon on a guide area according to one embodiment of the present invention;

FIG. 7 is a diagram illustrating an example in which the mobile terminal displays a thumbnail in the guide area according to one embodiment of the present invention;

FIG. 8 is a diagram illustrating another example in which the mobile terminal displays a thumbnail in the guide area according to one embodiment of the present invention;

FIG. 9 is a diagram illustrating an example in which the mobile terminal executes an unlock release operation or application according to one embodiment of the present invention;

FIG. 10 is a diagram illustrating another example in which the mobile terminal executes the unlock release operation or application according to one embodiment of the present invention;

FIG. 11 is a diagram illustrating an example in which the mobile terminal displays the virtual home button on a random area according to one embodiment of the present invention;

FIG. 12 is a diagram illustrating an example in which the mobile terminal changes a size of the guide area depending on a movement of the mobile terminal according to one embodiment of the present invention;

FIG. 13 is a diagram illustrating an example in which the mobile terminal changes a position of the virtual home button according to one embodiment of the present invention;

FIG. 14 is a diagram illustrating another example in which the mobile terminal changes the position of the virtual home button according to one embodiment of the present invention;

FIG. 15 is a diagram illustrating an example in which the mobile terminal changes a shape of the virtual home based on an event according to one embodiment of the present invention;

FIG. 16 is a diagram illustrating another example in which the mobile terminal changes the shape of the virtual home based on an event according to one embodiment of the present invention;

FIG. 17 is a diagram illustrating an example in which the mobile terminal displays the virtual home button according to one embodiment of the present invention;

FIG. 18 is a diagram illustrating another example in which the mobile terminal displays the virtual home button according to one embodiment of the present invention;

FIG. 19 is a diagram illustrating a further example in which the mobile terminal displays the virtual home button according to one embodiment of the present invention;

FIG. 20 is a diagram illustrating an example in which the mobile terminal generates a micro current on the virtual home button according one embodiment of the present invention;

FIG. 21 is a diagram illustrating an example in which the mobile terminal generates a different micro current on the virtual home button based on an event according to one embodiment of the present invention;

FIG. 22 is a diagram illustrating another example in which the mobile terminal generates a different micro current on the virtual home button based on an event according to one embodiment of the present invention;

FIG. 23 is a diagram illustrating a further example in which the mobile terminal generates a different micro current on the virtual home button based on an event according to one embodiment of the present invention;

FIG. 24 is a diagram illustrating an example in which the mobile terminal displays information on at least one of the virtual home button and an area for the virtual home button according to one embodiment of the present invention;

FIG. 25 is a diagram illustrating another example in which the mobile terminal displays information on at least one of the virtual home button and the virtual home button area according to one embodiment of the present invention;

FIG. 26 is a diagram illustrating a further example in which the mobile terminal displays information on at least one of the virtual home button and the virtual home button area according to one embodiment of the present invention;

FIG. 27 is a diagram illustrating an example in which the mobile terminal changes the shape of the virtual home button based on a displayed content according to one embodiment of the present invention;

FIG. 28 is a diagram illustrating another example in which the mobile terminal changes the shape of the virtual home button based on a displayed content according to one embodiment of the present invention;

FIG. 29 is a diagram illustrating an example in which the mobile terminal changes the shape of the virtual home button based on an input signal according to one embodiment of the present invention;

FIG. 30 is a diagram illustrating an example in which the mobile terminal displays an unlock pattern according to one embodiment of the present invention;

FIG. 31 is a diagram illustrating another example in which the mobile terminal displays an unlock pattern according to one embodiment of the present invention;

FIG. 32 is a diagram illustrating an example in which the mobile terminal does not display an unlock pattern according to one embodiment of the present invention;

FIG. 33 is a diagram illustrating an example in which the mobile terminal displays an unlock pattern based on an inclination of the mobile terminal according to one embodiment of the present invention;

FIG. 34 is a diagram illustrating an example in which the mobile terminal displays an unlock pattern based on an input signal according to one embodiment of the present invention;

FIG. 35 is a diagram illustrating another example in which the mobile terminal displays an unlock pattern based on an input signal according to one embodiment of the present invention; and

FIG. 36 is a diagram illustrating an example in which the mobile terminal changes the virtual home button based on an event according to one embodiment of the present invention.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

When an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

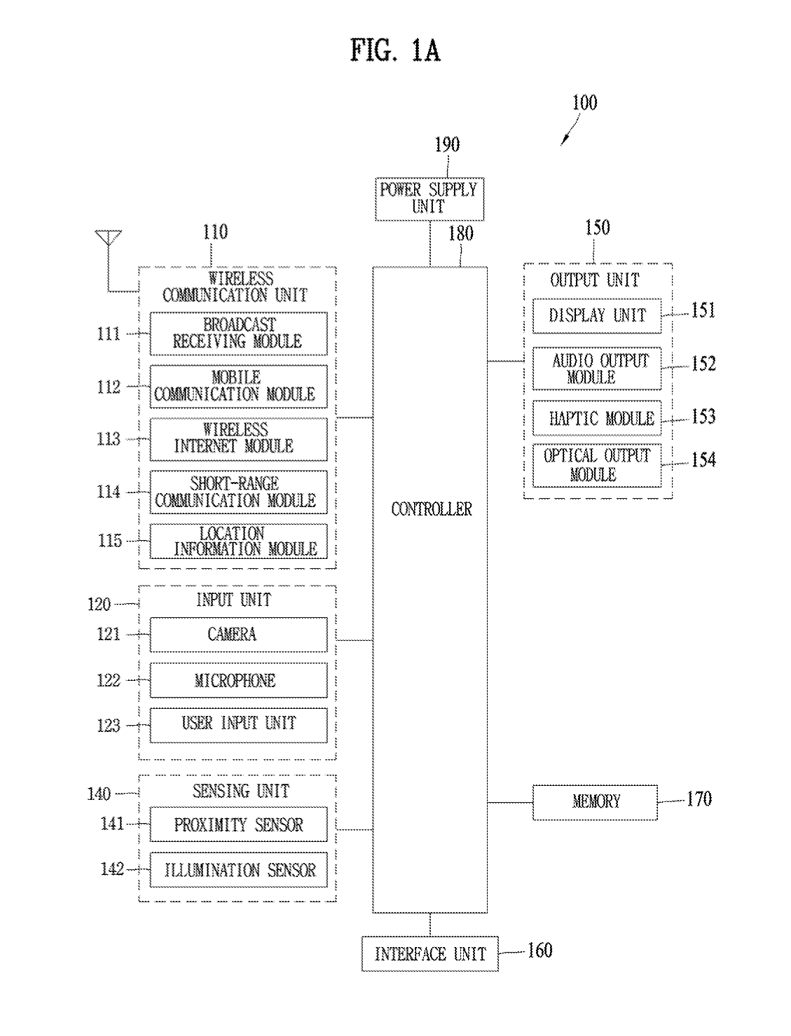

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. Implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 can utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 can store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 can provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery can be embedded in the terminal body, or configured to be detachable from the terminal body.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this instance, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which can exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 can permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. Further, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. The touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor can convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 can sense which region of the display unit 151 has been touched. Here, the touch controller may be a component separate from the controller 180, the controller 180, and combinations thereof.

In some embodiments, the controller 180 can execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor. Implementing the camera 121 with a laser sensor may allow detection of a touch of a physical object with respect to a 3D stereoscopic image. The photo sensor may be laminated on, or overlapped with, the display device. The photo sensor can scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented so the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 can typically control the general operations of the mobile terminal 100. For example, the controller 180 can set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 can recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed so synthetic resin or metal extends from a side surface to a rear surface.

If desired, the mobile terminal 100 may include a waterproofing unit for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor can sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like. The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this instance, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof. Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit can permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123. The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject. As shown in FIG. 1C, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

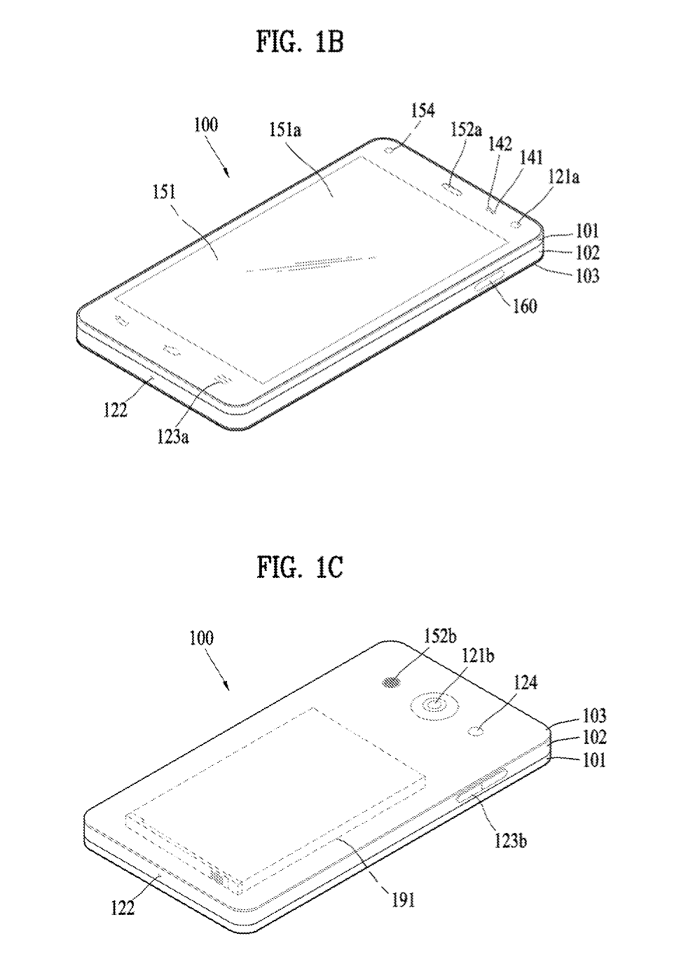

FIG. 2 is a conceptual view of a deformable mobile terminal according to an alternative embodiment of the present invention. In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In general, mobile terminal 200 can include features that are the same or similar to that of mobile terminal 100 of FIGS. 1A-1C.

The flexible display of mobile terminal 200 is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When the flexible display unit 251 is not deformed (for example, in a state with an infinite radius of curvature and referred to as a first state), a display region of the flexible display unit 251 includes a generally flat surface. When the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized so a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, when an external force is applied to the flexible display unit 251, the flexible display unit 251 may transition to the second state such that the flexible display unit is deformed into the flat state (or a less curved state) or into a more curved state.

If desired, the flexible display unit 251 may implement a flexible touch screen using a touch sensor in combination with the display. When a touch is received at the flexible touch screen, the controller 180 can execute certain control corresponding to the touch input. In general, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140.

The deformation sensor may be located in the flexible display unit 251 or the case 201 to sense information related to the deforming of the flexible display unit 251. Examples of such information related to the deforming of the flexible display unit 251 may be a deformed direction, a deformed degree, a deformed position, a deformed amount of time, an acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some embodiments, controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251.

A battery located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

In accordance with still further embodiments, a mobile terminal may be configured as a device which is wearable on a human body. Such devices go beyond the usual technique of a user grasping the mobile terminal using their hand. Examples of the wearable device include a smart watch, a smart glass, a head mounted display (HMD), and the like.

A typical wearable device can exchange data with (or cooperate with) another mobile terminal 100. In such a device, the wearable device generally has functionality that is less than the cooperating mobile terminal. For instance, the short-range communication module 114 of a mobile terminal 100 may sense or recognize a wearable device that is near-enough to communicate with the mobile terminal. In addition, when the sensed wearable device is a device which is authenticated to communicate with the mobile terminal 100, the controller 180 can transmit data processed in the mobile terminal 100 to the wearable device via the short-range communication module 114, for example. Hence, a user of the wearable device can use the data processed in the mobile terminal 100 on the wearable device. For example, when a call is received in the mobile terminal 100, the user can answer the call using the wearable device. Also, when a message is received in the mobile terminal 100, the user can check the received message using the wearable device.

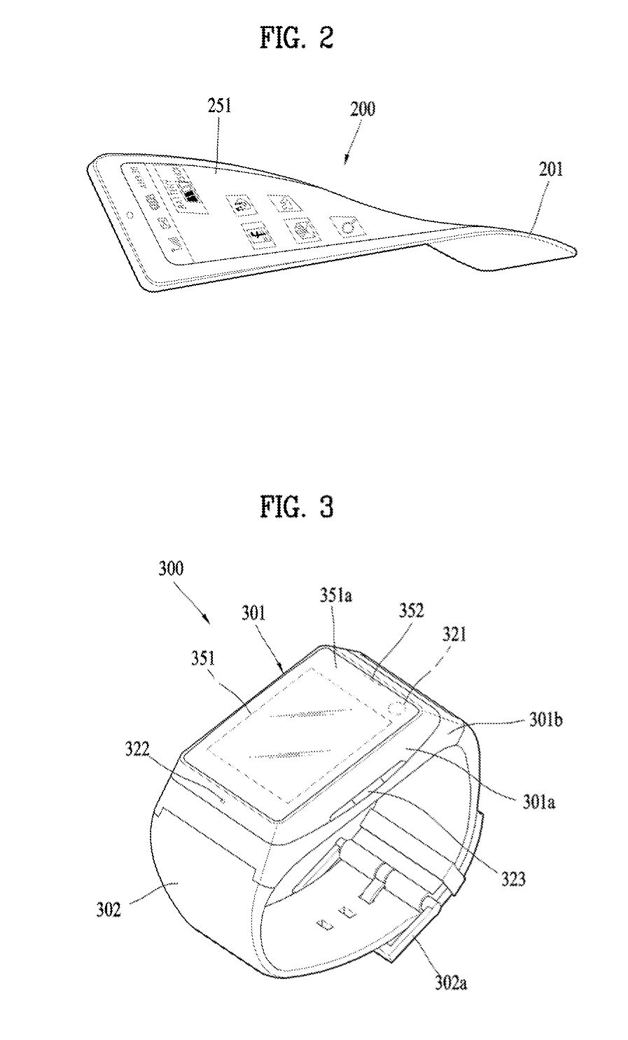

FIG. 3 is a perspective view illustrating one example of a watch-type mobile terminal 300 in accordance with another exemplary embodiment. As illustrated in FIG. 3, the watch-type mobile terminal 300 includes a main body 301 with a display unit 351 and a band 302 connected to the main body 301 to be wearable on a wrist. In general, mobile terminal 300 can include features that are the same or similar to that of mobile terminal 100 of FIGS. 1A-1C.

The main body 301 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 300 can perform wireless communication, and an antenna for the wireless communication can be installed in the main body 301. The antenna may extend its function using the case. For example, a case including a conductive material may be electrically connected to the antenna to extend a ground area or a radiation area.

The display unit 351 is shown located at the front side of the main body 301 so that displayed information is viewable to a user. In some embodiments, the display unit 351 includes a touch sensor so that the display unit can function as a touch screen. As illustrated, window 351a is positioned on the first case 301a to form a front surface of the terminal body together with the first case 301a.

The illustrated embodiment includes audio output module 352, a camera 321, a microphone 322, and a user input unit 323 positioned on the main body 301. When the display unit 351 is implemented as a touch screen, additional function keys may be minimized or eliminated. For example, when the touch screen is implemented, the user input unit 323 may be omitted.

The band 302 is commonly worn on the user's wrist and may be made of a flexible material for facilitating wearing of the device. As one example, the band 302 may be made of fur, rubber, silicon, synthetic resin, or the like. The band 302 may also be configured to be detachable from the main body 301. Accordingly, the band 302 may be replaceable with various types of bands according to a user's preference.

In one configuration, the band 302 may be used for extending the performance of the antenna. For example, the band may include therein a ground extending portion electrically connected to the antenna to extend a ground area.

The band 302 may include fastener 302a. The fastener 302a may be implemented into a buckle type, a snap-fit hook structure, a Velcro® type, or the like, and include a flexible section or material. The drawing illustrates an example that the fastener 302a is implemented using a buckle.

Hereinafter, embodiments related to methods for controlling the above-mentioned mobile terminal will be described with accompanying drawings. It will be apparent to those skilled in the art that the present invention may be embodied in other specific forms without departing from the spirit and essential characteristics of the invention.

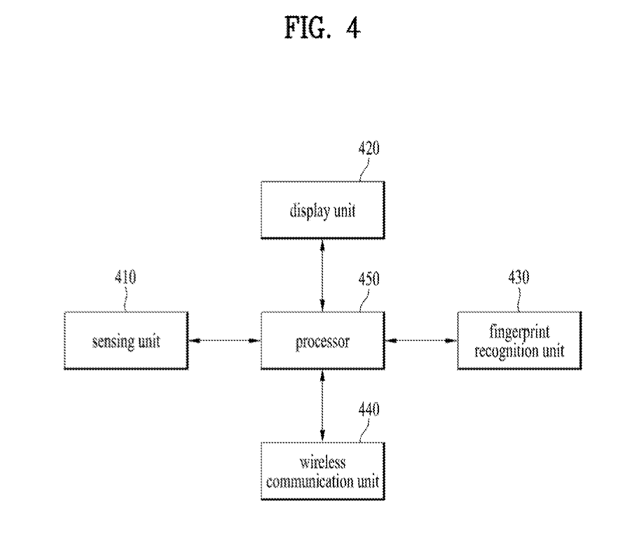

The mobile terminal, which will be described with reference to FIGS. 4 to 34, can be implemented using one of the mobile terminals 100, 200, and 300 illustrated in FIGS. 1 to 3. In the following description, the embodiments of the present invention will be explained with reference to FIGS. 4 to 34. In addition, the foregoing description with reference to FIGS. 1 to 3 is provided for ease in description and understanding of the embodiments of the present invention.

FIG. 4 is a diagram illustrating configuration modules of the mobile terminal according to one embodiment of the present invention. Referring to FIG. 4, the mobile terminal includes a sensing unit 410, a display unit 420, a fingerprint recognition unit 430, and a processor 450.

The sensing unit 410 can sense not only various user inputs input into the mobile terminal but also an environment of the mobile terminal and deliver a sensing result to enable the processor 450 to perform operation based on the sensing result. In the present invention, the sensing unit 410 may be disposed on the display unit 420 so as to be implemented as a touch screen. In addition, to implement the sensing unit 410, the sensing unit 140 of FIG. 1A may be used.

In addition, the sensing unit 410 can sense a touch input signal from a user. The sensing unit 410 can sense a point at which the touch input signal is sensed or a touched area. That is, the sensing unit 410 can distinguish between a point and an area where the touch input signal is sensed.

In addition, the sensing unit 410 can recognize a movement of the mobile terminal, an inclination of the mobile terminal, a grip state of the mobile terminal. Details will be described later.

The display unit 420 can display visual information including a text, an indicator, an icon, a content, an application, an image, a video, etc. In addition, the display unit 420 can display the visual information on a screen based on a control command from the processor 450. Moreover, the display unit 420 can be implemented using the display unit 151 in FIG. 1A or the display unit 351 in FIG. 3A.

In addition, the display unit 420 can display a virtual home button. The virtual home button may correspond to a non-fixed home button icon displayed on the display unit. In addition, when an input signal is sensed, the virtual home button can be displayed without output of a default value.

In addition, when an event is detected, the display unit 420 can change the virtual home button and then display the changed virtual home button. Moreover, the display unit 420 can display an area at a predetermined range from the virtual home button as a guide area or guide home button area. Furthermore, the display unit 420 can display a notification icon or a thumbnail corresponding to an application in the guide area. Further, the display unit 420 can display information related to the displayed content on at least one of the virtual home button and virtual home button area.

Additionally, the display unit 420 can display an unlock pattern based on at least one of a point at which an input signal is sensed by the sensing unit 410, an inclination of the mobile terminal, and a grip state. Details will be described later.

The fingerprint recognition unit 430 can sense at least one fingerprint input and extract fingerprint information from the sensed fingerprint input. Particularly, the fingerprint recognition unit 430 can detect a touch (or a fingerprint input) input on the fingerprint recognition unit 430 using at least one of a plurality of fingerprint recognition sensors such as an optical sensor, a thermal detection sensor, a semiconductor sensor, etc.

In addition, the fingerprint recognition sensor 430 can have an inter-layered structure or an integrated structure with the display unit 420. In addition, the fingerprint recognition sensor 430 may also have an inter-layered structure or an integrated structure with the sensing unit 410. That is, according to an embodiment of the present invention, since the fingerprint recognition unit 430 can be connected to the entirety of the display unit 420, the mobile terminal can authorize a fingerprint even when the fingerprint is detected at a random point of the display unit 420.

When the fingerprint recognition unit 430 recognizes a fingerprint, the processor 440 can unlock the mobile terminal or an application that requires authorization. In addition, the fingerprint recognition unit 430 can recognize a fingerprint through the virtual home button. Details will be described later.

The wireless communication unit 440 of the mobile terminal can perform communication and transmit/receive data signals with another electronic device and a server. In the present invention, the wireless communication unit 440 can be implemented as the wireless communication unit 110 of FIG. 1A.

In addition, the wireless communication unit 440 can receive an event from an external device. The event may correspond to an event for the application installed in the mobile terminal. Details will be described later.

The processor 450 can perform processing on data, control individual units of the mobile terminal, and control data transmission and reception between the individual units. In the present invention, the processor 450 can be implemented as the controller 180 of FIG. 1A.

As an embodiment of the present invention, the processor 440 can control operations of the mobile terminal. However, for convenience of description, it is assumed that the mobile terminal performs/controls the operations.

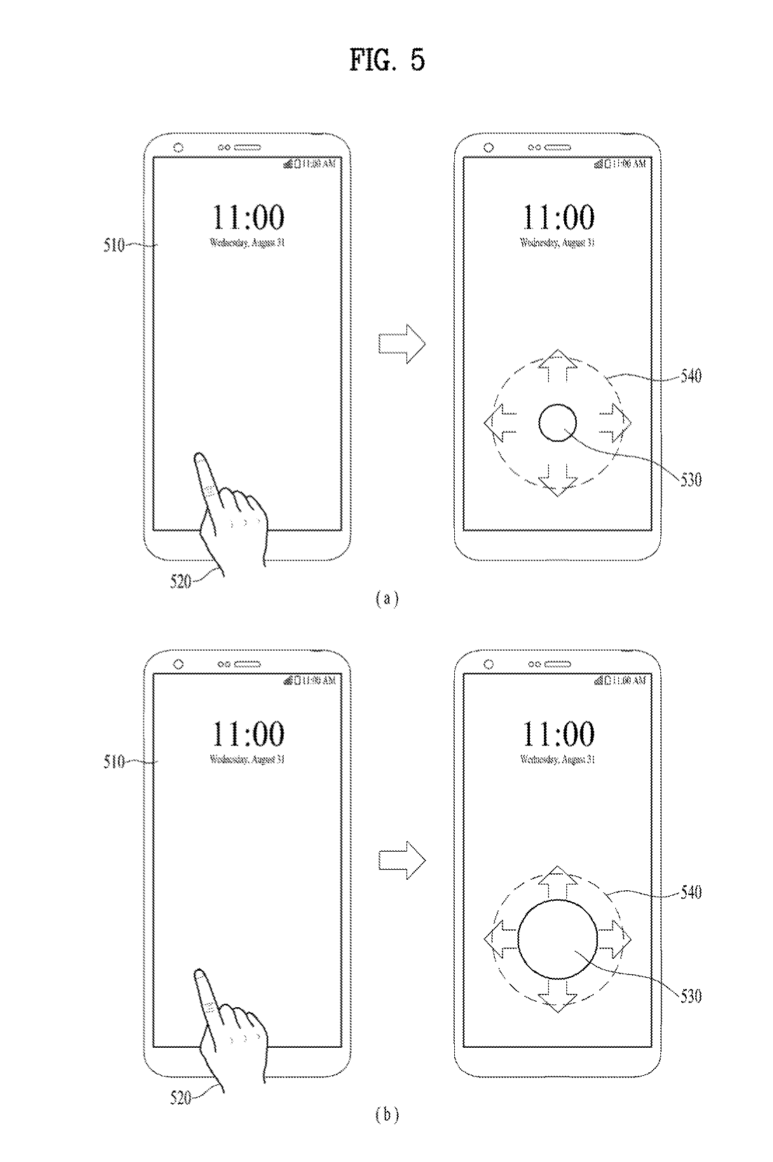

Next, FIG. 5 is a diagram illustrating an example in which the mobile terminal changes a size of a virtual home button depending on a movement of the mobile terminal according to one embodiment of the present invention.

FIG. 5 (a) shows an example of reducing the size of the virtual home button when the movement amount of the mobile terminal is large and FIG. 5 (b) shows an example of increasing the size of the virtual home button when the movement amount of the mobile terminal is small.

Referring to the first drawing of FIG. 5 (a), the mobile terminal can display a lock screen 510 on the display unit. The lock screen 510 restricts a user to input a control command for an application. For example, the lock screen 510 may correspond to a state in which only the current date and time are displayed.

Further, while displaying the lock screen 510, the mobile terminal can sense a first input signal 520. The first input signal 520 may be a touch input signal for selecting a random point on the display unit.

Referring to the second drawing of FIG. 5 (a), after sensing the first input signal 520, the mobile terminal can display a virtual home button 530 on the lock screen 510. The virtual home button 530 may perform the same functions as those performed by the physical home button disposed on the conventional mobile terminal. For example, when the user touches the displayed virtual home button 530, the mobile terminal can sense a user's fingerprint. In addition, when the sensed fingerprint matches a registered fingerprint, the mobile terminal can be unlocked.

In addition, the mobile terminal can sense a movement of the mobile terminal while or before displaying the virtual home button 530. When the movement of the mobile terminal is greater than a predetermined value, the mobile terminal can reduce the size of the virtual home button 530. In more detail, when the movement of the mobile terminal is greater than the predetermined value, the mobile terminal can reduce the size of the virtual home button 530, which is determined by a default value or a user configuration, based on the movement of the mobile terminal. For example, when the user touches the mobile terminal that currently displays the lock screen 510 while taking a bus, the mobile terminal can reduce the size of the virtual home button 530.

In addition, the mobile terminal can set an area at a predetermined range from the virtual home button as a guide area 540. In addition, although FIG. 5 shows that the configured guide area 540 is currently displayed, the mobile terminal can not display the configured guide area 540.

When the virtual home button 530 moves out of the guide area 540, the mobile terminal can be unlocked. In more detail, when the mobile terminal detects that the virtual home button 530 moves out of the guide area 540 by sensing an input signal of dragging, swiping, or flicking the virtual home button 530, the mobile terminal can be unlocked and terminate display of the lock screen 510.

Thus, when the size of the virtual home button 530 is small, the user needs to move the virtual home button 530 a little bit more in order to unlock the mobile terminal. That is, when the movement amount of the mobile terminal is large, the mobile terminal can reduce the size of the virtual home button 530 to prevent unlocking malfunction.

Meanwhile, referring to the first drawing of FIG. 5 (b), the mobile terminal can display the lock screen 510 on the display unit. Further, while displaying the lock screen 510, the mobile terminal can sense the first input signal 520. The first input signal 520 may be the same as the signal shown in the first drawing of FIG. 5 (a).

Referring to the second drawing of FIG. 5 (b), after sensing the first input signal 520, the mobile terminal can display the virtual home button 530 on the lock screen 510. In addition, the mobile terminal can sense the movement of the mobile terminal while or before displaying the virtual home button 530.

When the movement of the mobile terminal is smaller than the predetermined value, the mobile terminal can increase the size of the virtual home button 530. In more detail, when the movement of the mobile terminal is smaller than the predetermined value, the mobile terminal can significantly change the size of the virtual home button 530, which is determined by a default value or a user configuration, based on the movement of the mobile terminal.

For example, when the user touches the mobile terminal that currently displays the lock screen 510 while the mobile terminal is connected to a cradle, the mobile terminal can increase the size of the virtual home button 530. When an event is not detected during a predetermine time, the mobile terminal can also increase the size of the virtual home button 530.

In more detail, when the mobile terminal senses the first input signal 520 after the mobile terminal does not move during a predetermined time, the mobile terminal can increase the size of the virtual home button 530. For example, when the user touches the mobile terminal that currently displays the lock screen 510 after elapse of a predetermined time after the mobile terminal has been connected to the cradle, the mobile terminal can increase the size of the virtual home button 530.

Thus, when the size of the virtual home button 530 is large, the user can unlock the mobile terminal by moving the virtual home button 530 slightly. That is, when the mobile terminal is in a stationary state or slightly moves, the mobile terminal can increase the size of the virtual home button 530 to improve user convenience because there may be no malfunction.

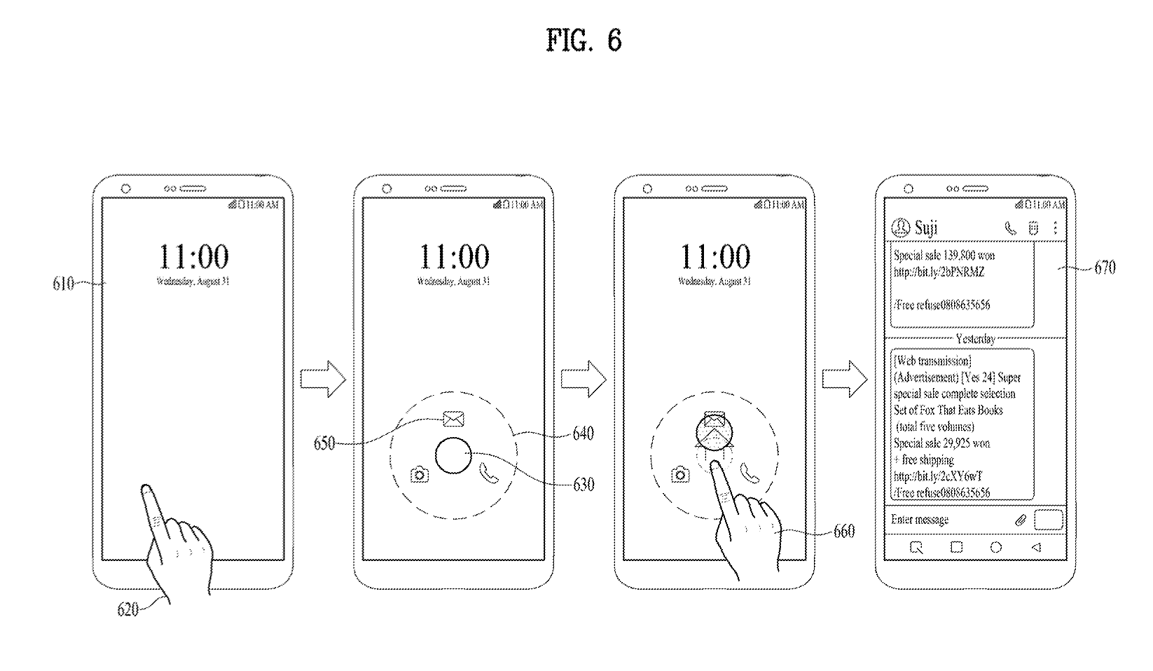

Next, FIG. 6 is a diagram illustrating an example in which the mobile terminal displays a notification icon on a guide area according to one embodiment of the present invention. Referring to the first drawing of FIG. 6, the mobile terminal can display a lock screen 610 on the display unit. In addition, the mobile terminal can sense a first input signal 620 for selecting a random point on the lock screen 610 while displaying the lock screen 610. Unlike the embodiment of FIG. 5, in the embodiment of FIG. 6, it is assumed that the mobile terminal receives an event.

Referring to the second drawing of FIG. 6, after sensing the first input signal 610, the mobile terminal can display a virtual home button 630 and a guide area 640 at a predetermined range from the virtual home button 630. When receiving an event, the mobile terminal can display a notification icon 650 corresponding to the event in the guide area 640. Here, the event may include a message, call, and mail received from the outside. In addition, when the mobile terminal receives a plurality of events, the mobile terminal can display a plurality of notification icons 650.

In more detail, the mobile terminal can receive various events from an external device or server. In addition, when the mobile terminal senses the first input signal 620 after receiving an event, the mobile terminal can display not only the virtual home button 630 and the guide area 640 but also the notification icon 650 corresponding to the event. For example, if the received event is a message, the mobile terminal can display the virtual home button 630, the guide area 640, and the notification icon 650 corresponding to the message on the lock screen 610 after sensing the first input signal 620.

Referring to the third drawing of FIG. 6, the mobile terminal can sense a second input signal 660 for moving the virtual home button 630 to the notification icon 650. The second input signal 660 may be a touch input signal for selecting the virtual home button 630 and moving the virtual home button 630 to the notification icon 650 through dragging, swiping, or flicking

Referring to the fourth drawing of FIG. 6, after sensing the second input signal 660, the mobile terminal can be unlocked and launch an application 670 corresponding to the event on the display unit. In more detail, when the virtual home button 630 is out of the guide area 640, the unlocking of the mobile terminal can be performed as described above with reference to FIG. 5. However, since unlike FIG. 5, it is assumed in FIG. 6 that the mobile terminal receives an event, the mobile terminal can be unlocked and then launch the application 670 corresponding to the displayed notification icon 650 after receiving the second input signal 660 for moving the virtual home button 630 to the notification icon 650.

Further, the mobile terminal can recognize a fingerprint through the virtual home button 630. In addition, if the recognized fingerprint matches a registered fingerprint, the mobile terminal can be unlocked and then launch the application 670.

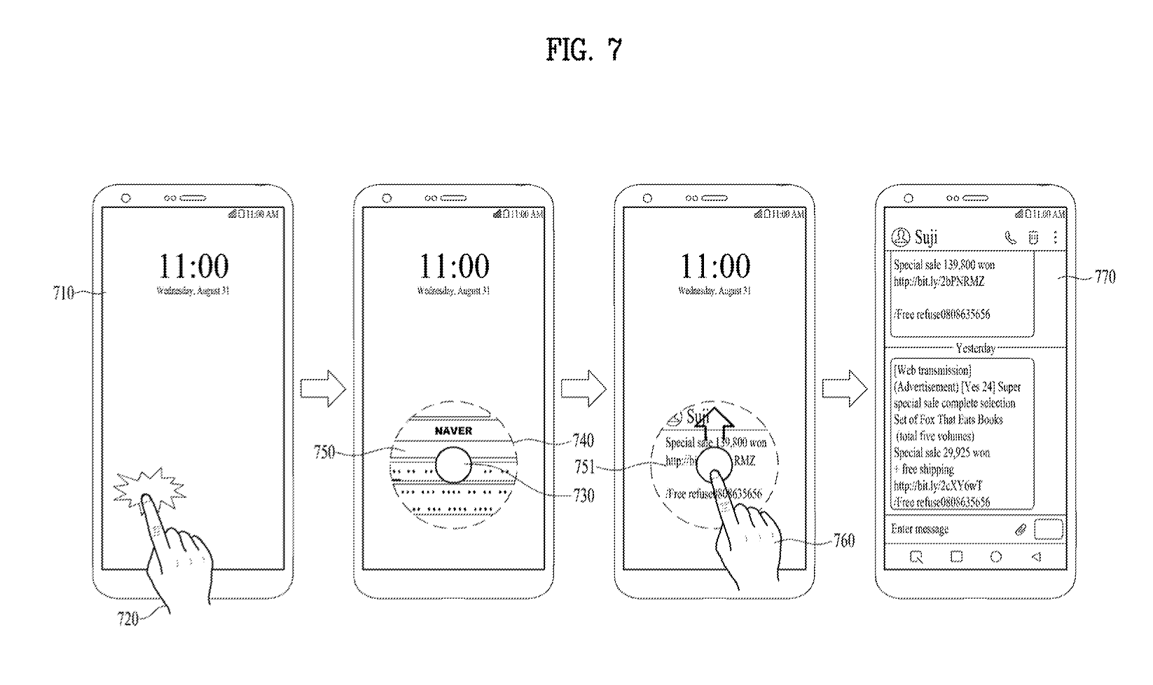

FIG. 7 is a diagram illustrating an example in which the mobile terminal displays a thumbnail in the guide area according to one embodiment of the present invention. Referring to the first drawing of FIG. 7, the mobile terminal can display a lock screen 710 on the display unit. In addition, the mobile terminal can sense a first input signal 720 for selecting a random point on the lock screen 710 while displaying the lock screen 710. The first input signal 720 may be a touch input signal touched with predetermined pressure during a predetermined time. That is, the first input signal 720 may be different from that of FIG. 5 or 6.

Referring to the second drawing of FIG. 7, after sensing the first input signal 720, the mobile terminal can display a virtual home button 730 and a guide area 740 on the lock screen 710. In addition, the mobile terminal can display a thumbnail corresponding to a background application in the guide area 740. The background application may be an application recently executed in the mobile terminal or an application executed in the background.

In addition, when there are a plurality of background applications, the mobile terminal can sequentially display thumbnails 750 corresponding to the background applications in the guide area 740. The mobile terminal can display a plurality of thumbnails 750 at a predetermined time interval.

In more detail, the mobile terminal can execute the background application even in the lock mode where a general application cannot be launched. After sensing the first input signal 720, the mobile terminal can display the thumbnail 750 corresponding to the background application on the guide area 740. For example, if the background application is a message application, the mobile terminal can display the thumbnail 750 corresponding to the message application on the guide area 740 after sensing the first input signal 720.

Referring the third drawing of FIG. 7, the mobile terminal can sense a second input signal 760 for moving the virtual home button 730 while displaying a first thumbnail 751 on the guide area 740. The second input signal 760 may be an input signal for moving the virtual home button 730 in a random direction unlike FIG. 6. For example, while the first thumbnail 751 is displayed on the guide area 740, the user can touch and move the virtual home button 730 in any directions.

Referring to the fourth drawing of FIG. 7, after sensing the second input signal 760, the mobile terminal can be unlocked and then launch an application 770 corresponding to the first thumbnail 751 on the display unit. In more detail, after sensing the second input signal 760, the mobile terminal can display the application 770 corresponding to the first thumbnail 751, which is displayed on the guide area 740, on the display unit.

In other words, after sensing the first input signal 720, the mobile terminal can sequentially display thumbnails 750 of applications, which are currently executed in the background, on the guide area 740. After sensing the second input signal 760, the mobile terminal can launch the application 770 corresponding to the first thumbnail 751 displayed on the guide area 740.

Further, the first and second input signals 720 and 760 can be input through continuous operation. For example, when the first thumbnail 751 is displayed on the guide area 740, the user can input the second input signal 760 for moving the virtual home button 730 in order to launch the application 770 while touching the lock screen 710 of the mobile terminal with predetermined pressure. Thus, when the thumbnail of the application which the user desires to launch is displayed on the guide area, the user can launch the application by moving the virtual home button even though the mobile terminal is locked.

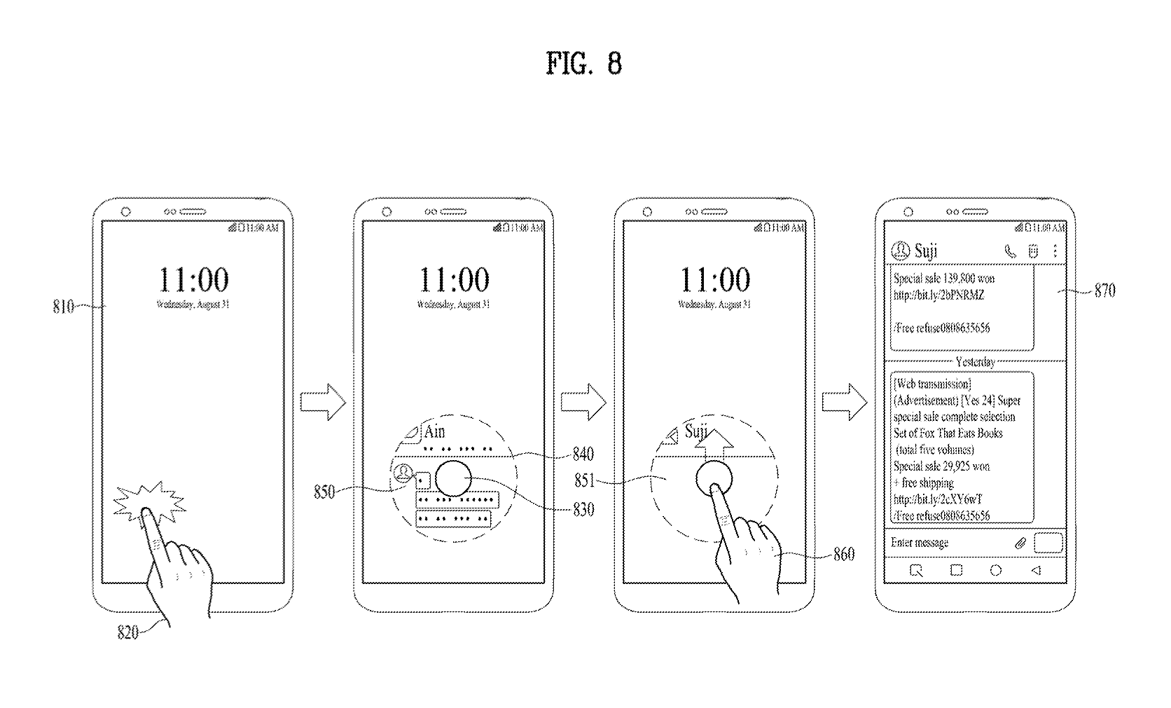

Next, FIG. 8 is a diagram illustrating another example in which the mobile terminal displays a thumbnail in the guide area according to one embodiment of the present invention.

Referring to the first drawing of FIG. 8, the mobile terminal can sense a first input signal 820 for selecting a random point on a lock screen 810 while displaying the lock screen 810. The first input signal 820 may be a touch input signal touched with predetermined pressure during a predetermined time. That is, the first input signal 820 may be the same as the input signal of FIG. 7. Unlike the embodiment of FIG. 7, in the embodiment of FIG. 8, it is assumed that the mobile terminal receives an event.

Referring to the second drawing of FIG. 8, after sensing the first input signal 820, the mobile terminal can display a virtual home button 830 and a guide area 840 on the lock screen 810. In addition, the mobile terminal can display a thumbnail 850 of an application corresponding to the received event on the guide area 840. That is, the mobile terminal can receive the event from an external device or a server as described above. When the mobile terminal receives the first input signal 820 after receiving the event, the mobile terminal can display the thumbnail 850 of the application corresponding to the received event.

In addition, when the mobile terminal receives a plurality of events, the mobile terminal can sequentially display thumbnails 850 of applications corresponding to the received events on the guide area 840. In the case, the mobile terminal can display a plurality of thumbnails 850 at a predetermined time interval. For example, if the received event is a message, the mobile terminal can display the thumbnail 850 of a message application on the guide area 840 after sensing the first input signal 820.

Referring to the third drawing of FIG. 8, while displaying a first thumbnail 851 on the guide area 840, the mobile terminal can sense a second input signal 860 for moving the virtual home button 830. The second input signal 860 may be the same as the input signal of FIG. 7.

Referring to the fourth drawing of FIG. 8, after sensing the second input signal 860, the mobile terminal can be unlocked and then launch an application 870 corresponding to the first thumbnail 851 on the display unit. Thus, when the thumbnail of the application corresponding to the received event is displayed on the guide area, the user can launch the application corresponding to the received event by moving the virtual home button even though the mobile terminal is locked.

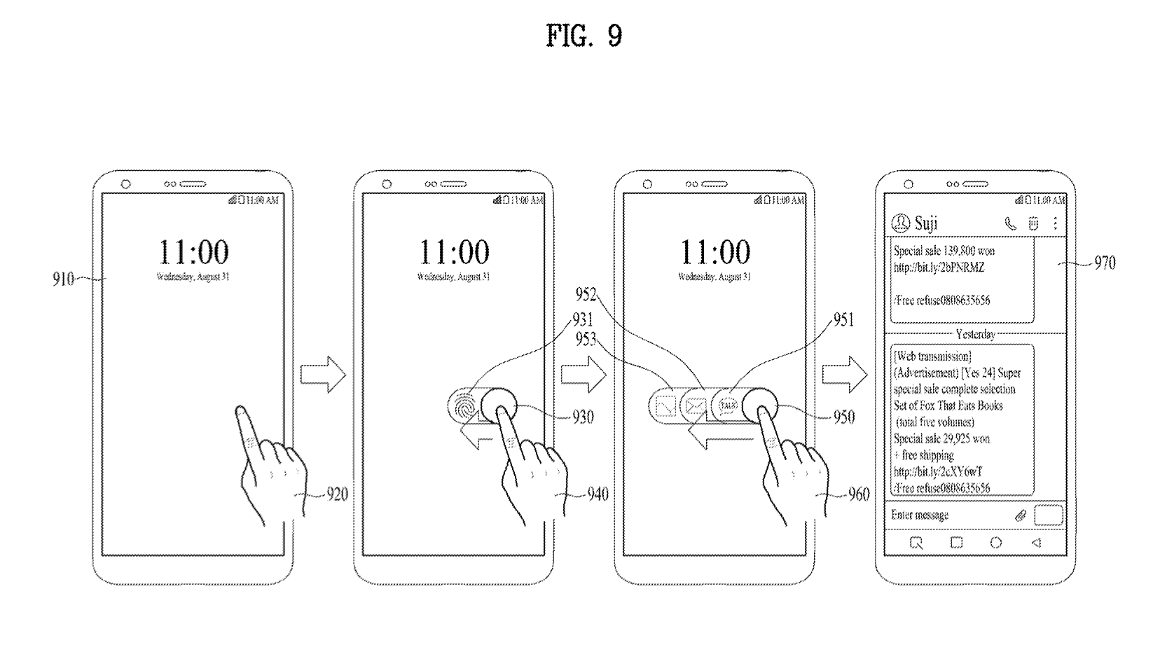

FIG. 9 is a diagram illustrating an example in which the mobile terminal executes an unlock release operation or application according to one embodiment of the present invention. Referring to the first drawing of FIG. 9, while displaying a lock screen 910 on the display unit, the mobile terminal can sense a first input signal 920. The first input signal 920 may be a touch input signal for selecting a random point on the lock screen 910.

Referring to the second drawing of FIG. 9, after sensing the first input signal 920, the mobile terminal can display a virtual home button 930 on the point at which the first input signal 920 is sensed. In more detail, since the mobile terminal can display the virtual home button rather than a physical home button, the mobile terminal can display the virtual home button 930 on the point at which the first input signal 920 is sensed.

In addition, the mobile terminal can simultaneously display the virtual home button 930 and a fingerprint recognition button 931. The fingerprint recognition button 931 may be used to perform a function of recognizing a fingerprint using the fingerprint recognition unit.

In addition, the fingerprint recognition button 931 may be overlaid with the virtual home button 930 unlike FIG. 9. The mobile terminal can also sense a second input signal 940 that selects the virtual home button 930 and then slides it in the direction where the fingerprint recognition button 931 is placed. The first and second input signals 920 and 940 may be continuously input. For example, the user can touch the lock screen 910 to output the virtual home button 930 and the fingerprint recognition button 931 and then drag the touch in the direction of the fingerprint recognition button 931 to authorize the fingerprint.

If the recognized fingerprint matches a registered fingerprint, the mobile terminal can be unlocked. On the contrary, if the recognized fingerprint does not match the registered fingerprint, the mobile terminal cannot be unlocked. Hereinafter, assume that the recognized fingerprint matches the registered fingerprint.

If the mobile terminal detects release of the second input signal 940 after sensing the second input signal 940, the mobile terminal can instantaneously release the lock and then display a home screen. That is, when the mobile terminal detects the release of the touch after sensing the second input signal 940, the mobile terminal can terminate display of the lock screen 910 and then display the home screen instead of performing the embodiment shown in the third drawing of FIG. 9. In addition, the mobile terminal can display a user interface for showing that the virtual home button 930 is moved toward the fingerprint recognition button 931 after sensing the second input signal 940.

Referring to the third drawing of FIG. 9, when the fingerprint recognized through the fingerprint recognition button 931 matches the registered fingerprint, the mobile terminal can display an icon 950 corresponding to a background application on the side of the virtual home button 930. When there are a plurality of background applications, the mobile terminal can display a plurality of icons 950 on the side of the virtual home button 930. For example, the mobile terminal can display a first icon 951, a second icon 952, and a third icon 953 on the side of the virtual home button 930.

The first icon 951 may be an icon for a messenger application, the second icon 952 may be an icon for a message application, and the third icon 953 may be an icon for a gallery application. In addition, the mobile terminal can sense a third input signal 960 that selects the virtual home button 930 and then slides it toward the icons 950.

Referring to the fourth drawing of FIG. 9, after sensing the third input signal 960, the mobile terminal can launch an application corresponding to an icon 950 located at the point where the touch is released. In more detail, when sensing the third input signal 960 that selects the virtual home button 930 and then slides it toward the second icon 950, the mobile terminal can launch the application corresponding to the second icon 952. For example, if the second icon 252 is an icon for a message application, the mobile terminal can launch the message application after sensing the third input signal 960.

In addition, the third input signal 960 may be continuously input together with the first and second input signals 920 and 940. For example, the user can touch the lock screen 910 to output the virtual home button 930 and the fingerprint recognition button 931 and then drag the touch in the direction of the fingerprint recognition button 931 to authorize the fingerprint. In addition, when the recognized fingerprint matches the registered fingerprint, the user can further drag the touch in the direction of the displayed icon 950 in order to launch an application.

Further, the mobile terminal can display a user interface for showing that the virtual home button 930 is moved toward the second icon 952 after sensing the third input signal 960. Unlike the above-described embodiment, the mobile terminal can sense a predetermined touch input signal as the first input signal 920 in the first drawing of FIG. 9. For example, the mobile terminal can sense a touch input signal touched with predetermined pressure during a predetermined time as the first input signal 920.

After sensing the first input signal 920, the mobile terminal can simultaneously display the virtual home button 930 and the icon 950 corresponding to the background application. In other words, when sensing the first input signal 920 as shown in the first drawing of FIG. 9, the mobile terminal can perform the embodiment shown in the third drawing of FIG. 9.

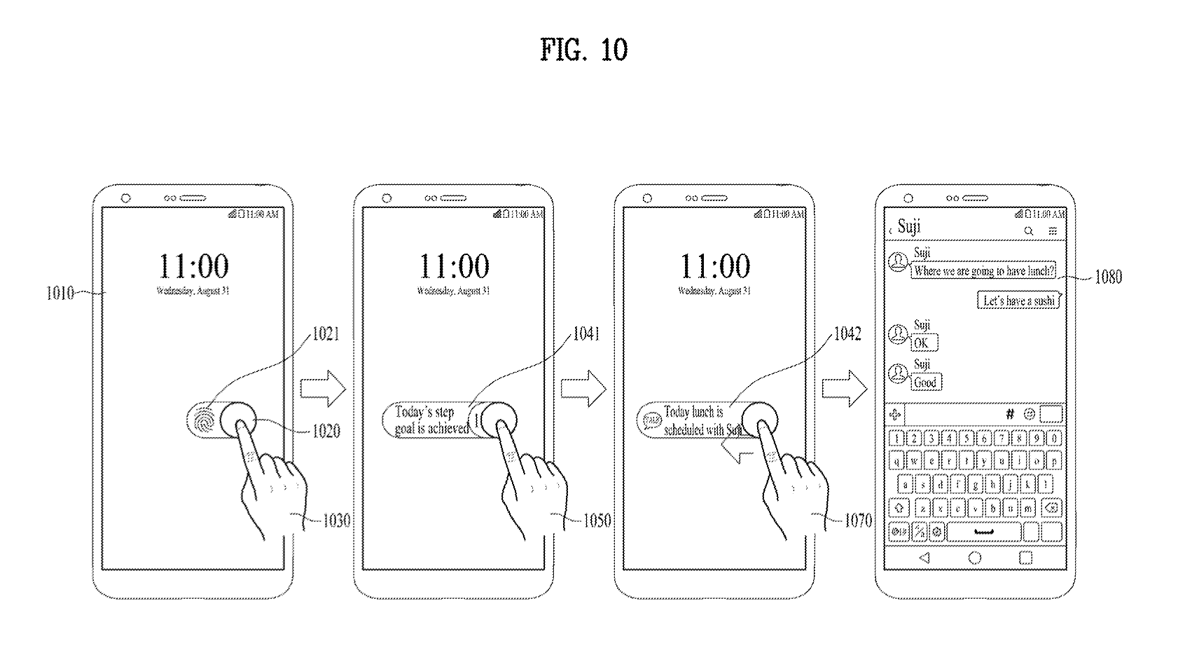

Next, FIG. 10 is a diagram illustrating another example in which the mobile terminal executes the unlock release operation or application according to one embodiment of the present invention. The first drawing of FIG. 10 may match the second drawing of FIG. 9. That is, the mobile terminal currently displays a virtual home button 1020 and a fingerprint recognition button 1021 while displaying a lock screen 1010.

Unlike the embodiment of FIG. 9, in the embodiment of FIG. 10, it is assumed that the mobile terminal receives an event. In addition, the mobile terminal can sense a first input signal 1030 for selecting the virtual home button 1020. The first input signal 1030 may be a predetermined touch input signal for inputting a fingerprint through the fingerprint recognition button 1021. In addition, it is assumed in the embodiment of FIG. 10 that the recognized fingerprint matches the registered fingerprint.

Referring to the second drawing of FIG. 10, after sensing the first input signal 1030, the mobile terminal can display a first event preview 1041 of the received event. The first event preview 1041 may be displayed on the side of the virtual home button 1020. In addition, the first event preview 1041 may include brief information on the event received by the mobile terminal.

For example, the mobile terminal can receive a first event of ‘today's step goal is achieved’ from a running application. When the mobile terminal senses the first input signal 1030 after receiving the first event, the mobile terminal can display the first event preview 1041 on the lock screen 1010.

In addition, if the mobile terminal receives a plurality of events, the mobile terminal can display the number of the remaining event previews while displaying the first event preview 1041. Thus, the user can know that a plurality of events are received.

In addition, the mobile terminal senses a second input signal 1050 for selecting the virtual home button 1020 again while display the first event preview 1041. The second input signal 1050 may be a touch input signal input again after the first input signal 1030 is input or a touch input signal continuously input with the first input signal 1030.

Referring to the third drawing of FIG. 10, after sensing the second input signal 1050, the mobile terminal can display a second event preview 1042. The second event preview may be for an event different from the first the first event. For example, the mobile terminal can receive a second event of ‘today lunch is scheduled with Suji’ from a messenger application. In this instance, when the mobile terminal senses the second input signal 1050 after receiving the second event, the mobile terminal can display the second event preview 1042.

Further, the display order of the first and second event previews 1041 and 1042 can be determined based on time. In addition, the mobile terminal can sense a third input signal 1070 for sliding the virtual home button 1020 in the direction of the second event preview 1042.

Referring to the fourth drawing of FIG. 10, after sensing the third input signal 1070, the mobile terminal can release the lock and, at the same time, launch an application 1080 corresponding to the second event preview 1042.

According to the aforementioned embodiment, if the second event preview 1042 is a preview of the second event received from the messenger application, the mobile terminal can release the lock and, at the same time, launch the messenger application 1080 after sensing the third input signal 1070. In addition, when launching the messenger application, the mobile terminal can instantaneously display a screen for the second event. That is, even when the mobile terminal is locked, the user can instantaneously use the application associated with the received event using the virtual home button.

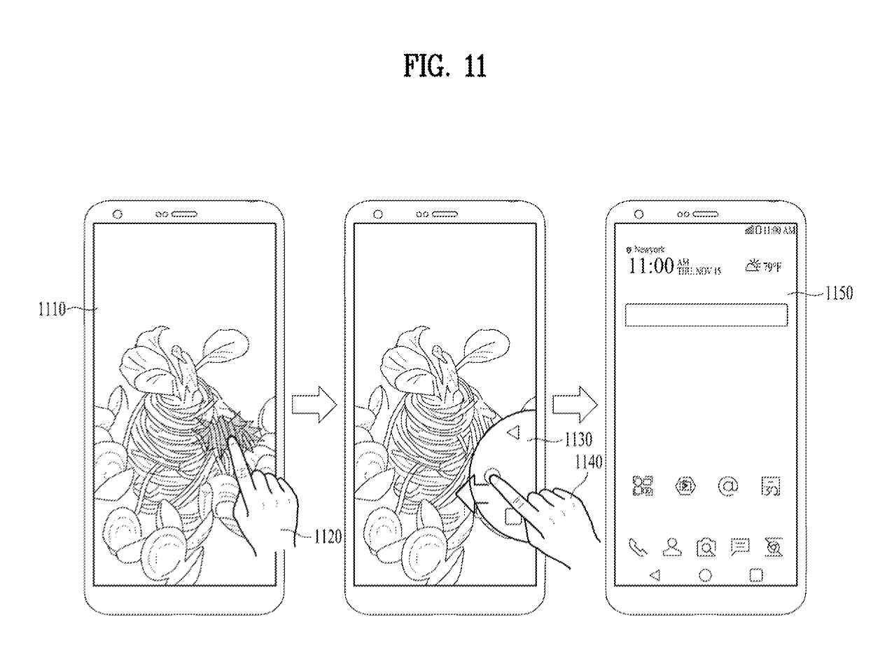

FIG. 11 is a diagram illustrating an example in which the mobile terminal displays the virtual home button on a random area according to one embodiment of the present invention. Referring to the first drawing of FIG. 11, the mobile terminal can display a content 1110 on the display unit. The content 1110 may include various applications. For example, the mobile terminal can display a gallery application, a camera application, or a vide application on the display unit.

In addition, the mobile terminal can sense a first input signal 1120 while displaying the content 1110. The first input signal 1120 may be a predetermined touch input signal. For example, the first input signal 1120 may be an input signal touched at a random point of the displayed content 1110 with predetermined pressure during a predetermined time.

Referring to the second drawing of FIG. 11, after sensing the first input signal 1120, the mobile terminal can display a virtual home button 1130 at the location where the first input signal is sensed. In addition, the virtual home button 1130 may include at least one button to which a different function is mapped. In addition, the virtual home button may include a back key, a home key, and a recent key.

In more detail, the back key may be a key for displaying a screen prior to the content currently displayed on the mobile terminal, the home key may be a key for displaying the home screen, and the recent key may be a key for displaying a list of applications executed in the background. Also, the mobile terminal can sense a second input signal 1140 for selecting the home key. In addition, Further, the mobile terminal can also sense an input signal for selecting the back key or recent key.

Referring to the third drawing of FIG. 11, after sensing the second input signal 1140, the mobile terminal can stop display of the content 1110 and then display a home screen 1150. Referring to the above-mentioned example, if the mobile terminal senses the input signal for selecting the back key or recent key, the mobile terminal can display the screen prior to the currently displayed content 1110 or the list of the applications executed in the back ground.

In other words, when the user uses an application that needs to be watched through the full screen such as the gallery application, camera application, and video application, the user can use the application without display of the home button. If necessary, the mobile terminal can display the virtual home button at the point where the user desires and then use the mapped function.

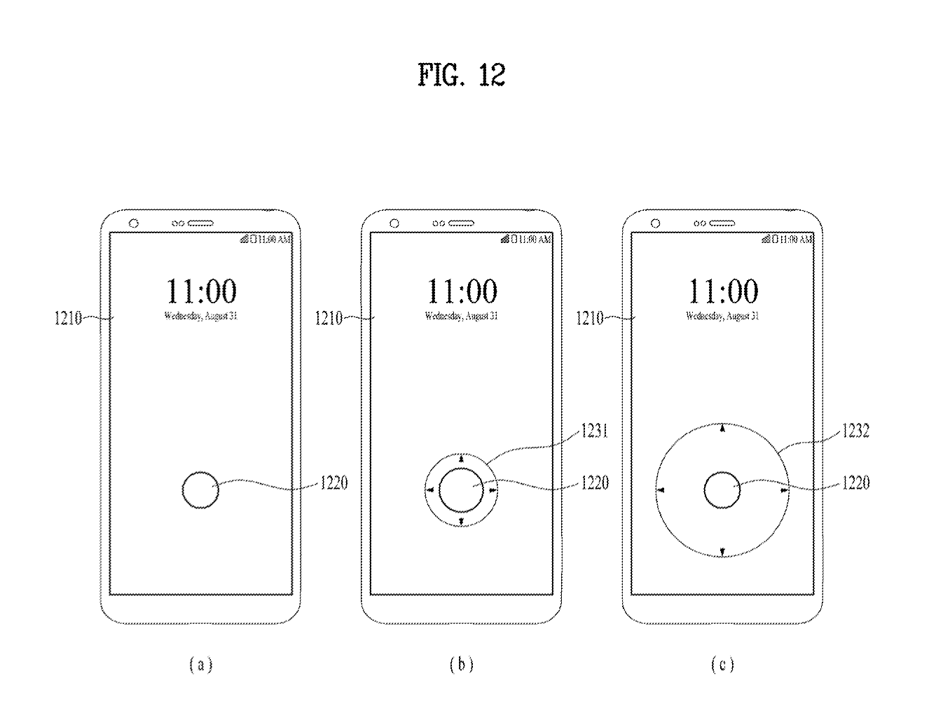

FIG. 12 is a diagram illustrating an example in which the mobile terminal changes a size of the guide area depending on a movement of the mobile terminal according to one embodiment of the present invention. FIGS. 12 (a) to (c) show that the mobile terminal displays a virtual home button 1220 based on a first input signal (not shown in the drawings) while displaying a lock screen 1210. Unlike FIG. 5, FIG. 12 shows an embodiment in which the size of the guide area is changed depending on the movement of the mobile terminal.

FIG. 12 (a) shows a case in which the mobile terminal does not almost move, FIG. 12 (b) shows a case in which the movement amount of the mobile terminal is normal, and FIG. 12 (c) shows a case in which the movement amount of the mobile terminal is large. Referring to FIG. 12 (a) in which the mobile terminal does not almost move, if the mobile terminal senses a first input signal, the mobile terminal can display only a virtual home button 1220. That is, when the mobile terminal does not almost move, the mobile terminal can not display a guide area.

If a second input signal for moving the virtual home button 1220 is sensed, the mobile terminal can be unlocked. Referring to FIG. 12 (b) in which the movement amount of the mobile terminal is normal, if the mobile terminal senses the first input signal, the mobile terminal can display the virtual home button 1220 and a first guide area 1231.

That is, when the movement amount of the mobile terminal is normal, the mobile terminal can display the first guide area 1231 at a predetermined range from the virtual home button 1220. If a second input signal for moving the virtual home button 1220 out of the first guide area 1231 is sensed, the mobile terminal can be unlocked.

Referring to FIG. 12 (c) in which the movement amount of the mobile terminal is large, if the mobile terminal senses the first input signal, the mobile terminal can display the virtual home button 1220 and a second guide area 1232. The second guide area 1232 may be formed further away from the virtual home button 1220 than the first guide area 1231. That is, when the movement amount of the mobile terminal is large, the mobile terminal can enlarge the guide area.

In addition, if a second input signal for moving the virtual home button 1220 out of the second guide area 1232 is sensed, the mobile terminal can be unlocked. In other words, according to the embodiment of FIG. 12, the guide area size can be adjusted unlike FIG. 5. Specifically, when the movement amount of the mobile terminal is large, the guide area size is increased so that the user should move the virtual home button more, thereby preventing malfunction. Further, when the movement amount of the mobile terminal is small, the guide area is not displayed so that the user can unlock the mobile terminal by moving the virtual home button in a simple manner.

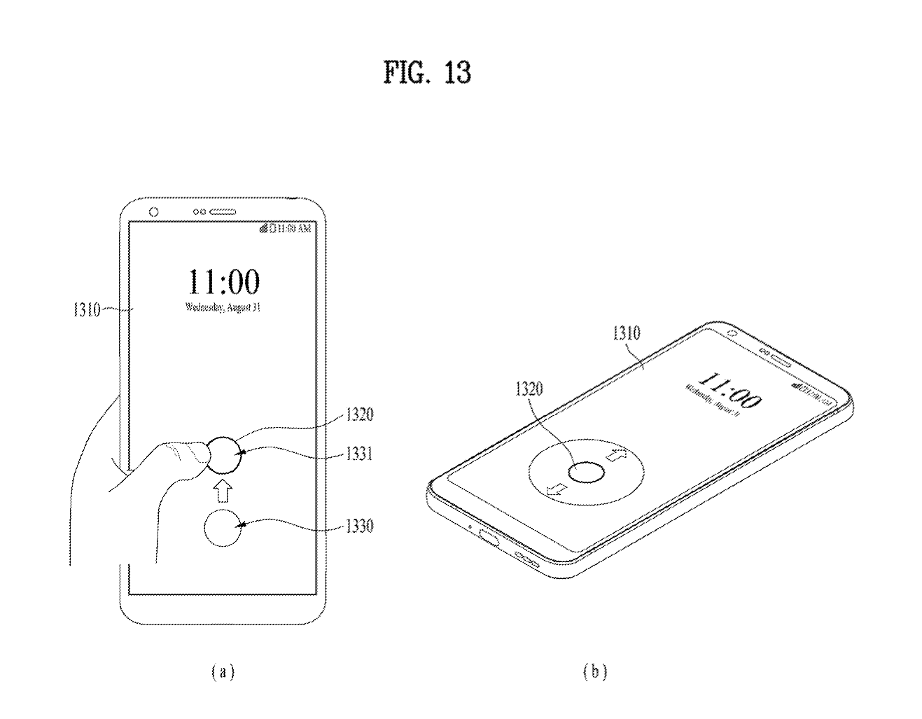

FIG. 13 is a diagram illustrating an example in which the mobile terminal changes a position of the virtual home button according to one embodiment of the present invention. Specifically, FIGS. 13 (a) and (b) shows examples in which the mobile terminal changes a size or a position of the virtual home button depending on its state.

According to the embodiment of FIG. 13, while displaying a lock screen 1310 on the display unit, the mobile terminal can display a virtual home button by receiving an input signal as described above. In addition, even when there is no input signal, the mobile terminal can display the virtual home button.

FIG. 13 (a) shows a case in which the user holds the mobile terminal and FIG. 13 (b) shows a case in which the mobile terminal is placed on something. That is, the user can use the mobile terminal while holding it with the user's hand, connecting it to the cradle, or placing it on the floor.

Referring to FIG. 13 (a), while the user grips the mobile terminal, the mobile terminal can move a virtual home button 1320 from a first position 1330 to a second position 1331. For example, the first position 1330 may be included in the bottom of the display unit of the mobile terminal and the second position 1331 may be included in the middle portion of the display unit of the mobile terminal.

In more detail, in the case of a normal mobile terminal, the virtual home button 1320 can be displayed on the bottom of the display unit of the mobile terminal. However, when the user grips the mobile terminal, a location of the thumb for touching the virtual home button 1320 may be changed depending on how the user grips the mobile terminal.

Referring to FIG. 13 (a) again, when the user grips the mobile terminal, the user's thumb may be located at the center of the display unit rather than the bottom of the display unit. Thus, the mobile terminal can display the virtual home button at the second position 1331 by detecting the user's grip state.

In addition, the mobile terminal can be unlocked based on an input signal for selecting the virtual home button 1320. That is, the mobile terminal can change the display position of the virtual home button 1320 in consideration of the user's grip state in order to allow the user to easily unlock the mobile terminal.

Referring to FIG. 13 (b), when the mobile terminal is placed on something, the mobile terminal can increase the size of the virtual home button 1320. Here, the case in which the mobile terminal is placed on something may include all cases except the case in which the user grips the mobile terminal. For example, cases in which the user connects the mobile terminal to the cradle or places the mobile terminal on the floor while sleeping, driving or working are included.

In more detail, when the mobile terminal is placed on something, the mobile terminal can enlarge the virtual home button 1320. That is, when the user does not use or grip the mobile terminal during a predetermined time or more, the mobile terminal can increase the size of the virtual home button 1320 such that the user can unlock the mobile terminal by slightly moving the virtual home button 1320.

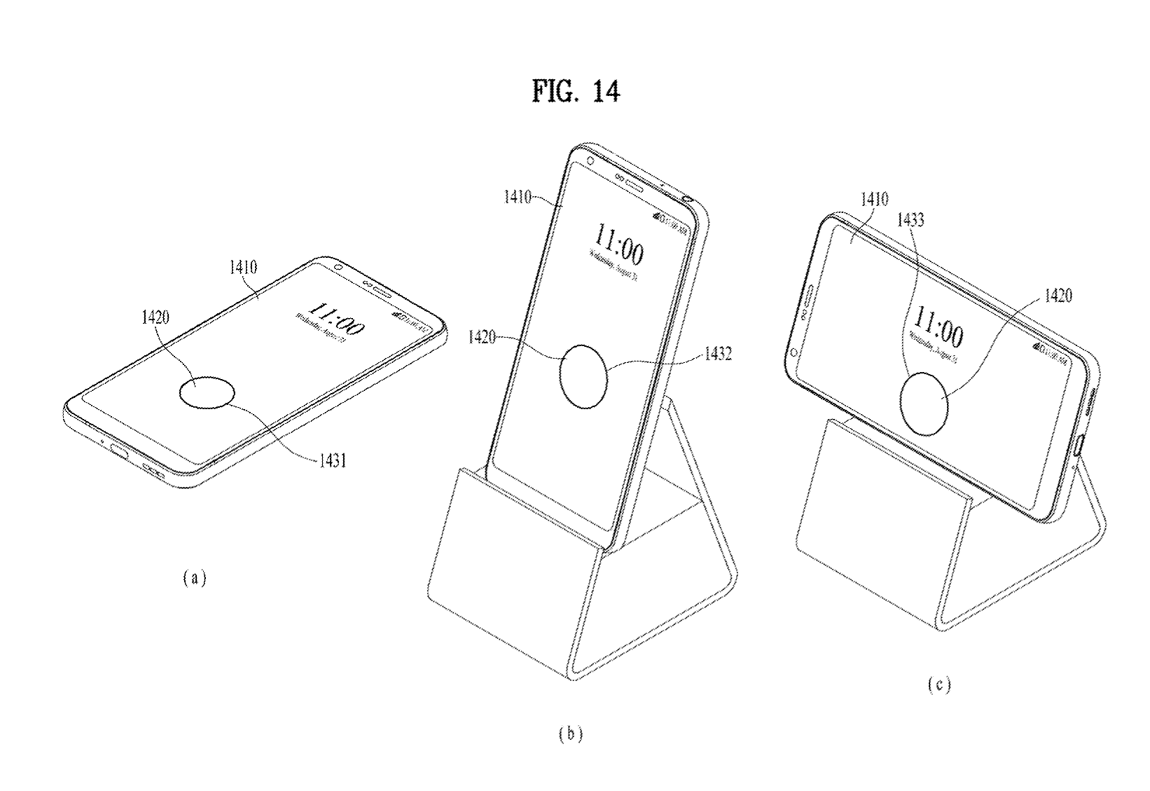

FIG. 14 is a diagram illustrating another example in which the mobile terminal changes the position of the virtual home button according to one embodiment of the present invention. Specifically, FIGS. 14 (a) to (c) show examples in which the mobile terminal changes the position of the virtual home button depending on how the mobile terminal is placed.

According to the embodiment of FIG. 14, while displaying a lock screen 1410 on the display unit, the mobile terminal can display a virtual home button by receiving an input signal as described above. In addition, even when there is no input signal, the mobile terminal can display the virtual home button.

FIG. 14 (a) shows a case in which the mobile terminal is placed on the floor, FIG. 14 (b) shows a case in which the mobile terminal is vertically connected to the cradle, and FIG. 14 (c) shows a case in which the mobile terminal is horizontally connected to the cradle. Referring to FIG. 14 (a), when the mobile terminal is placed on the floor, the mobile terminal can display a virtual home button 1420 at a first position 1431. The first position 1431 may be a default position of the virtual home button 1420. For example, the mobile terminal can display the virtual home button on the bottom center of the display unit.

Referring to FIG. 14 (b), when the mobile terminal is connected to the cradle in the vertical direction, the mobile terminal can display the virtual home button 1420 at a second position 1432. In this instance, by sensing an inclination of the mobile terminal, the mobile terminal can recognize whether the mobile terminal is connected to the cradle in the vertical direction or the horizontal direction.

The second position 1432 may be a position higher than the first position 1431. That is, FIG. 14 (b) may be similar to FIG. 13 (a). That is, the mobile terminal can display the virtual home button 1420 at the position higher than the default position in order to allow the user to easily touch the virtual home button 1420.

Referring to FIG. 14 (c), when the mobile terminal is connected to the cradle in the horizontal direction, the mobile terminal can display the virtual home button 1420 at a third position 1433. The third position 1433 may be the bottom center of the display unit when the mobile terminal is horizontally placed.

In other words, since the virtual home button can be freely moved on the display unit unlike the physical home button, the mobile terminal can move the virtual home button to a position that allows the user to easily touch the virtual home button by considering the vertical mode, horizontal mode, or inclination of the mobile terminal.

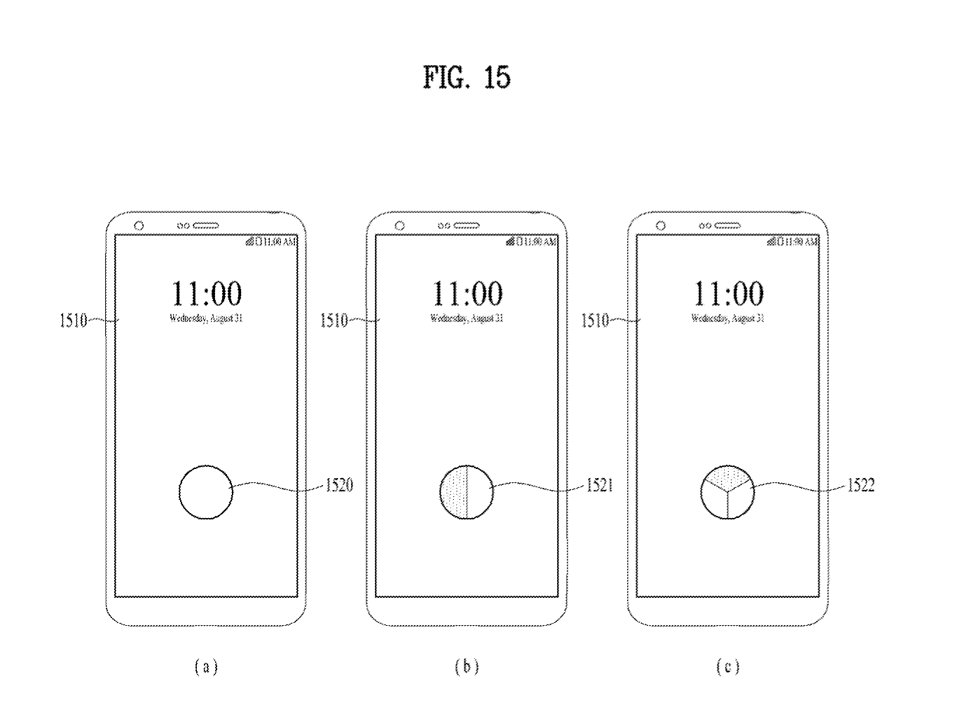

FIG. 15 is a diagram illustrating an example in which the mobile terminal changes a shape of the virtual home based on an event according to one embodiment of the present invention. In particular, FIGS. 15 (a) to (c) show examples in which the mobile terminal changes an inner shape of the virtual home button depending on the number of events received by the mobile terminal.

According to the embodiment of FIG. 15, while displaying a lock screen 1510 on the display unit, the mobile terminal can display a virtual home button by receiving an input signal as described above. In addition, even when there is no input signal, the mobile terminal can display the virtual home button.

FIG. 15 (a) shows when the mobile terminal receives no event, FIG. 15 (b) shows when the mobile terminal receives a single event, and FIG. 15 (c) shows when the mobile terminal receives three events. Referring to FIG. 15 (a), the mobile terminal can display a first virtual home button 1520 on a lock screen 1510. The first virtual home button 1520 may be formed in a shape of a circle, the inside of which is transparent.

If the mobile terminal receives an event, the mobile terminal can change the inside of the first virtual home button 1520 into a non-transparent state. In addition, the mobile terminal can adjust the brightness of the virtual home button 1520 depending on whether an event is received. For example, when the mobile terminal receives no event, the mobile terminal can decrease the brightness of the first virtual home button 1520. On the contrary, when the mobile terminal receives an event, the mobile terminal can increase the brightness of the first virtual home button 1520.

Referring to FIG. 15 (b), the mobile terminal can display a second virtual home button 1521 on the lock screen 1510. The second virtual home button 1521 may be formed in a shape of a circle, the inside of which is transparent and divided into two parts. Also, if the mobile terminal receives an event, the mobile terminal can change one of the two divided parts of the second virtual home button 1521 into the non-transparent state. In addition, if the mobile terminal receives two evens, the mobile terminal can change all of the two divided parts of the second virtual home button 1521 into the non-transparent state.

Referring to FIG. 15 (c), the mobile terminal can display a third virtual home button 1522 on the lock screen 1510. The third virtual home button 1522 may be formed in a shape of a circle, the inside of which is transparent and divided into three parts. If the mobile terminal receives an event, the mobile terminal can change one of the three divided parts of the third virtual home button 1522 into the non-transparent state.

In addition, if the mobile terminal receives two events, the mobile terminal can change two of the three divided parts of the third virtual home button 1522 into the non-transparent state. As described above, the user can confirm the number of events received by the mobile terminal through the virtual home button.

Further, in the aforementioned embodiment, division of the virtual home button, for example, the first to third home buttons 1520 to 1522 may be changed according to a user configuration. That is, the user can configure the number of received events displayed through the virtual home button on the lock screen 1510.

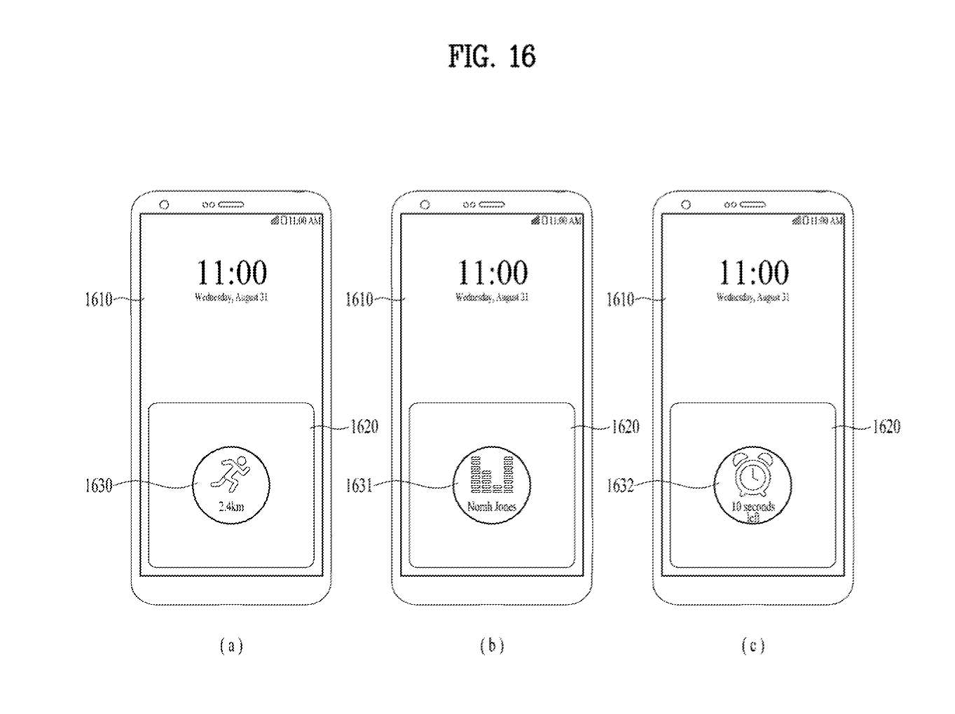

Next, FIG. 16 is a diagram illustrating another example in which the mobile terminal changes the shape of the virtual home based on an event according to one embodiment of the present invention. In particular, FIGS. 16 (a) to (c) shows examples in which when the mobile terminal receives an on-going event for a background application in the lock mode, the mobile terminal displays an icon for the event on the virtual home button. Here, the on-going event may mean events continuously received by the mobile terminal during a prescribed time rather than a single event.

Referring to FIG. 16 (a), while displaying a lock screen 1610, the mobile terminal can display a virtual home button area 1620. The virtual home button area 1620 may be an area extended from the virtual home button mentioned in the embodiments. That is, the user can unlock the mobile terminal by moving or touching the virtual home button area 1620.

In addition, the mobile terminal can receive a first on-going event while displaying the lock screen 1610 and the virtual home button area 1620. For example, the mobile terminal can receive an on-going event of ‘today's walking distance’ from a running application. That is, since the on-going event is received from the background application even when the mobile terminal is locked, the mobile terminal needs to display the received on-going event on the lock screen 1610.

After receiving the first on-going event, the mobile terminal can display a first icon 1630 corresponding to the first on-going event on the virtual home button area 1620. Referring to the above-mentioned example, when the first on-going event is ‘today's walking distance’ received from the running application, the mobile terminal can display an icon of ‘running’ and ‘walking distance’ as the first icon 1630. If sensing an input signal of touching the first icon 1630, the mobile terminal can release the lock and then launch an application corresponding to the first icon 1630.

Referring to FIG. 16 (b), the mobile terminal can receive a second on-going event while displaying the lock screen 1610 and the virtual home button area 1620. For example, the mobile terminal can receive an on-going event of ‘currently played music’ from a music playback application. After receiving the second on-going event, the mobile terminal can display a second icon 1631 corresponding to the second on-going event on the virtual home button area 1620. Referring to the above-mentioned example, when the second on-going event is ‘currently played music’ received from the music playback application, the mobile terminal can display an icon of ‘music’ and ‘name and singer of the currently played music’ as the second icon 1631.

Referring to FIG. 16 (c), the mobile terminal can receive a third on-going event while displaying the lock screen 1610 and the virtual home button 1620. For example, the mobile terminal can receive an on-going event of ‘remaining time until the set alarm’ from an alarm application. After receiving the third on-going event, the mobile terminal can display a third icon 1632 corresponding to the third on-going event on the virtual home button area 1620. Referring to the above-mentioned example, when the third on-going event is ‘remaining time until upcoming alarm’ received from the music playback application, the mobile terminal can display an icon of ‘alarm’ and ‘countdown until the set alarm’ as the third icon 1632.

In addition, when the mobile terminal receives a plurality of on-going events, the mobile terminal can display a plurality of icons on the virtual home button area 1620. For example, when the mobile terminal respectively receives on-going events of ‘today's walking distance’ and ‘currently played music’ from the running application and the music playback application, the mobile terminal can simultaneously display the first icon 1630 and the second icon 1631 on the virtual home button area 1620.

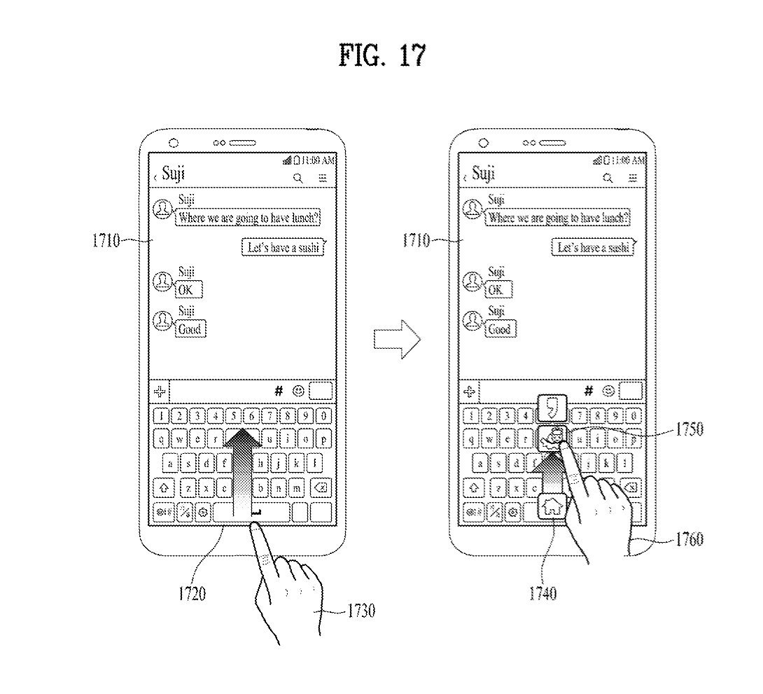

Next, FIG. 17 is a diagram illustrating an example in which the mobile terminal displays the virtual home button according to one embodiment of the present invention. Referring to the first drawing of FIG. 17, the mobile terminal can sense a first input signal 1730 of dragging a bezel part 1720 in a first direction while displaying a first content 1710 on the display unit. The bezel part 1720 may be a side part of the display unit of the mobile terminal. In addition, the first direction may be a direction from the bezel part 1720 to the center of the display unit and the first input signal 1730 may be an input signal of dragging the bezel part 1720 by a predetermined distance or more.

Referring to the second drawing of FIG. 17, after sensing the first input signal 1730, the mobile terminal can display a user interface for showing a virtual home button 1740 generated from the bezel part 1720. The mobile terminal can display the virtual home button 1740 over the first content 1710 in an overlapping manner.

In addition, the mobile terminal can further display at least one icon besides the virtual home button 1740 based on a drag distance of the first input signal 1730. That is, when the first input signal 1730 is dragged by the predetermined distance or more, the mobile terminal can further display an icon for a background application.

For example, if the first input signal 1730 is dragged by a first distance, the mobile terminal can display the virtual home button 1740 and a first icon 1750. If the first input signal 1730 is dragged by a second distance, the mobile terminal can display the virtual home button 1740, the first icon 1750, a second icon, a third icon, etc.

When sensing a second input signal 1760 for selecting the first icon 1750, the mobile terminal can launch an application corresponding to the first icon 1750. The second input signal 1760 may be an input signal of releasing the touch at the position of the first icon 1750 after the first input signal 1730 is input. In addition, the second input signal 1760 may be an input signal of touching the first icon 1750 again after the virtual home button 1740 and the first icon 1750 is displayed based on the first input signal 1730.

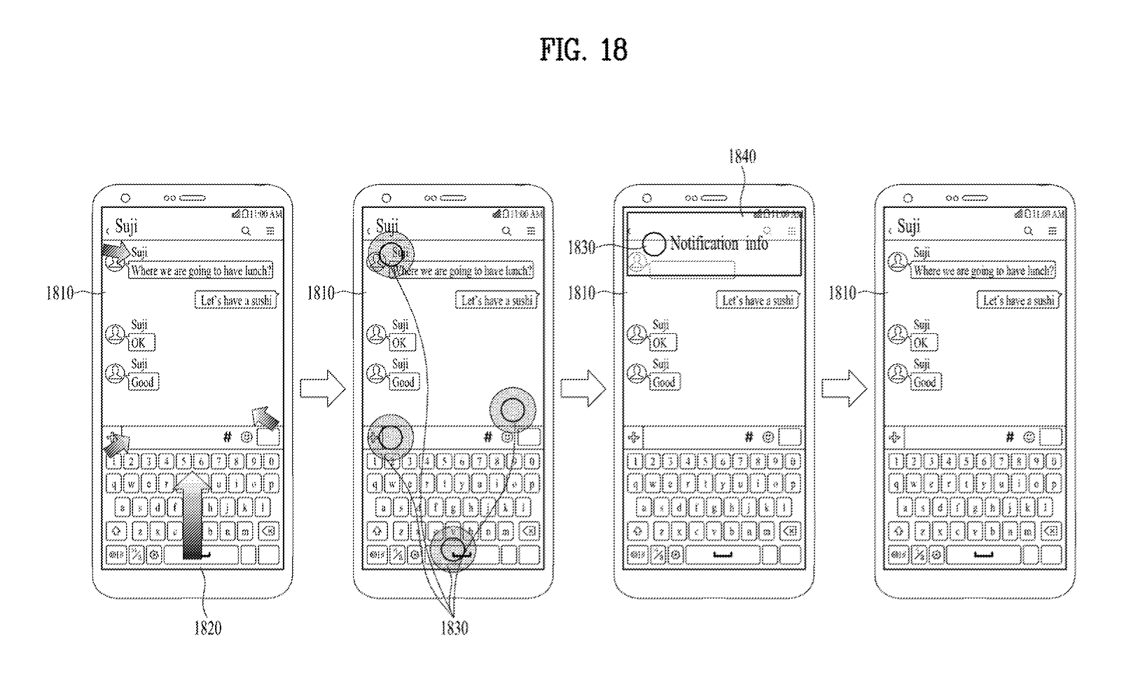

FIG. 18 is a diagram illustrating another example in which the mobile terminal displays the virtual home button according to one embodiment of the present invention. Referring to the first drawing of FIG. 18, while displaying a content 1810 on the display unit, the mobile terminal can sense a first input signal of dragging a bezel part 1820 in a first direction. The first direction may be a direction from the bezel part 1820 to the center of the display unit. Unlike the embodiment of FIG. 17, in the embodiment of FIG. 18, the user can touch a random point and drag the touch from the bezel part 1820 to the center of the display unit.

Referring to the second drawing of FIG. 18, the mobile terminal can display a virtual home button 1830 at the point where the first input signal is sensed. That is, the mobile terminal can display the virtual home button 1830 at the point close to the bezel part where the first input signal is initially sensed.

Referring to the third drawing of FIG. 18, if the mobile terminal receives an event, the mobile terminal can display the virtual home button 1830 at the point where the first input signal is sensed and, at the same time, display notification information 1840 corresponding to the received event. The notification information 1840 may be displayed on the side of the virtual home button 1830. Alternatively, the notification information 1840 may be displayed on the inside of the virtual home button 1830 by enlarging the virtual home button 1830.

Moreover, when sensing an input signal for selecting the notification information 1840, the mobile terminal can launch an application associated with the notification information 1840. That is, the second drawing of FIG. 18 shows an example of displaying the virtual home button 1830 based on the first input signal when no event is received. Further, the third drawing of FIG. 18 shows an example of displaying the virtual home button 1830 and the notification information 1840 corresponding to the event received by the mobile terminal.

Referring to the fourth drawing of FIG. 18, when the mobile terminal senses no input signal during a predetermined time after displaying the virtual home button 1830 or the virtual home button including the notification information 1840, the mobile terminal can stop display of the virtual home button 1830 or the virtual home button 1830 including the notification information 1840. When the mobile terminal senses an input signal for selecting a certain point rather than the virtual home button 1830 or the notification information 1840, the mobile terminal can stop display of the virtual home button 1830 or the virtual home button 1830 including the notification information 1840.

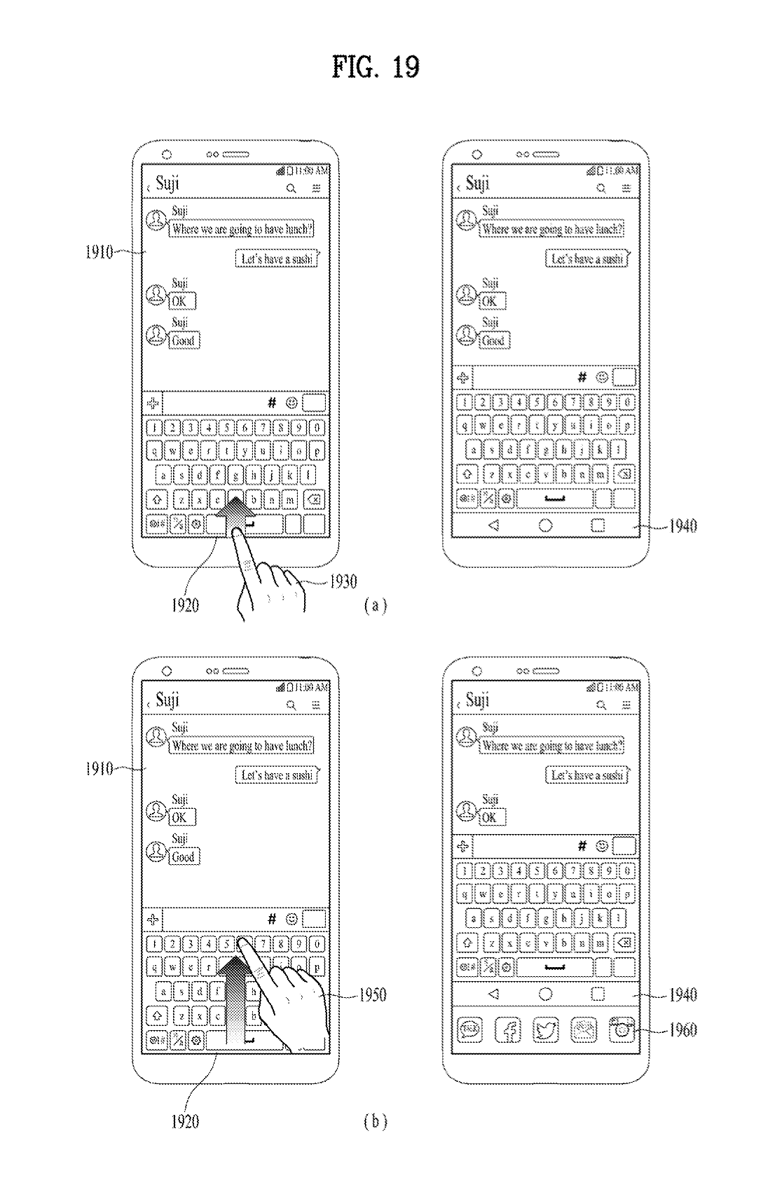

FIG. 19 is a diagram illustrating a further example in which the mobile terminal displays the virtual home button according to one embodiment of the present invention. FIGS. 19 (a) and (b) shows examples of displaying the virtual home button or at least one icon based on a drag distance of an input signal.

Referring to the first drawing of FIG. 19 (a), while displaying a content 1910 on the display unit, the mobile terminal can sense a first input signal 1930 of dragging a bezel part 1920 in a first direction by a first distance. The first direction may be a direction from the bezel part 1920 to the center of the display unit and the first distance may be any distance equal to or shorter than a predetermined distance.

Referring to the second drawing of FIG. 19 (a), after sensing the first input signal 1930, the mobile terminal can display a virtual home button 1940 at the point where the first input signal 1930 is sensed. The virtual home button 1940 may include a back key, a home key, and a recent key.

Referring to the first drawing of FIG. 19 (b), while displaying the content 1910 on the display unit, the mobile terminal can sense a second input signal 1950 of dragging the bezel part 1920 in the first direction by a second distance. The second distance may be any distance equal to or longer than the predetermined distance.

Referring to the second drawing of FIG. 19 (b), after sensing the second input signal 1950, the mobile terminal can display the virtual home button 1950 and at least one icon 1960 at the point where the second input signal 1950 is sensed. The at least one icon 1960 may be icons for launching applications. In addition, the at least one icon 1960 may be set as a default or configured by the user.

That is, FIG. 19 (a) shows an example of displaying only the virtual home button 1940 when the drag distance of the bezel part 1920 is short and FIG. 19 (b) shows an example of displaying not only the virtual home button 1940 but also the at least one icon 1960 when the drag distance of the bezel part 1920 is long. When the first input signal 1930 is dragged by the second distance without release of the touch after the virtual home button 1940 is displayed based on the first input signal 1930, the mobile terminal can display the at least one icon 1960.

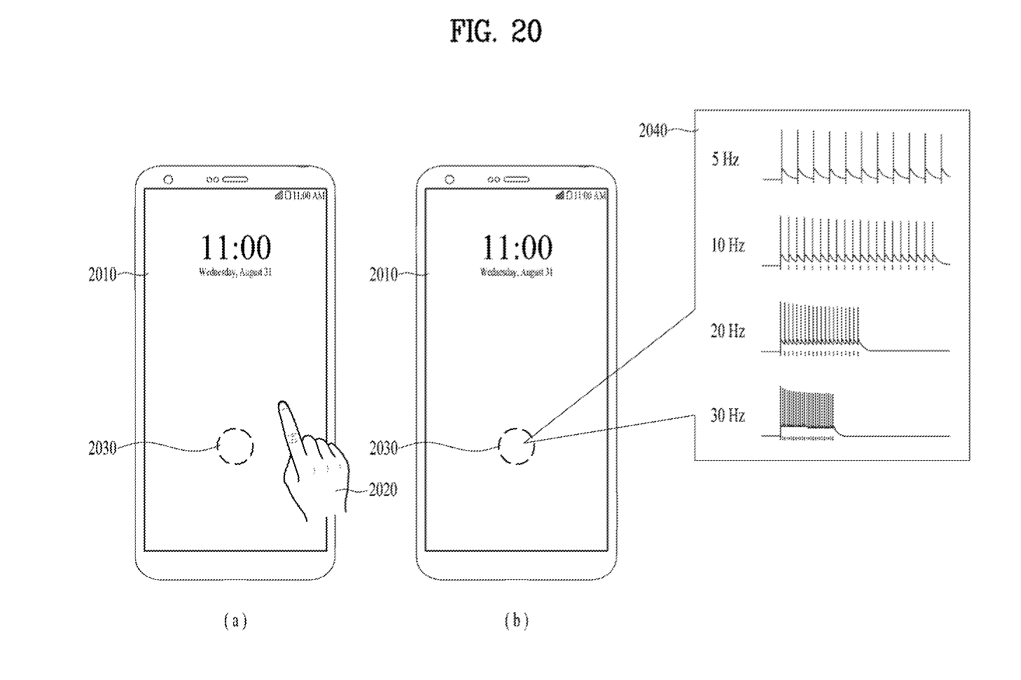

FIG. 20 is a diagram illustrating an example in which the mobile terminal generates a micro current on the virtual home button according one embodiment of the present invention. Referring to FIG. 20 (a), the mobile terminal can display a lock screen 2010 on the display unit. In addition, the mobile terminal can sense a first input signal 2020 for selecting a random point on the lock screen 2010.

In addition, the mobile terminal can display a virtual home button 2030 at a predetermined point on the lock screen 2010. The virtual home button 2030 is not displayed visually. That is, even though the user inputs the first input signal 2020 to the mobile terminal, nothing is displayed on the display unit except the lock screen 2010.

Referring to FIG. 20 (b), the mobile terminal can generate a micro current 2040 in the area on which the virtual home button 2030 is displayed. In more detail, the mobile terminal can generate the micro current 2040 using a sensor capable of generating a current such as a piezo sensor in the area on which the virtual home button 2030 is displayed based on the first input signal 2020.

The micro current 2040 generated in the area on which the virtual home button 2030 is displayed can have various frequencies. Thus, when the user touches the area on which the virtual home button 2030 is displayed even though the virtual home button 2030 is not visually displayed, the user can feel the micro current 2040 and thus recognize the location of the virtual home button 2030.

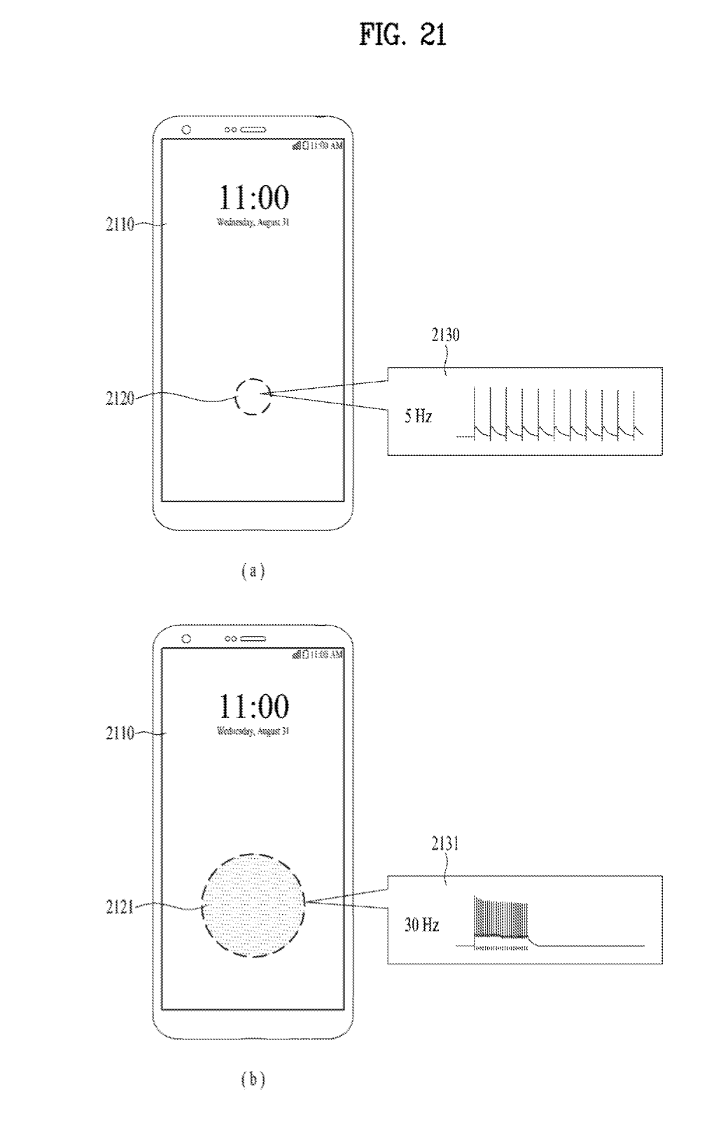

FIG. 21 is a diagram illustrating an example in which the mobile terminal generates a different micro current on the virtual home button based on an event according to one embodiment of the present invention. FIG. 21 (a) shows a virtual home button when no event is received and FIG. 21 (b) shows a virtual home button when an event is received.

Referring to FIG. 21 (a), while displaying a lock screen 2110, the mobile terminal can display a first virtual home button 2120. The first virtual home button 2120 may be a circular indicator, the inside of which is transparent. In addition, when no event is received, the mobile terminal can generate a micro current with a frequency equal to or smaller than a predetermined frequency only at a boundary of the virtual home button 2120.

Referring to FIG. 21 (b), while displaying the lock screen 2110, the mobile terminal can display a second virtual home button 2121. The second virtual home button 2121 may be a circular indicator, the inside of which is non-transparent. In this instance, a radius of the second home button 2121 may be greater than that of the first home button 2120, and an inside area of the second home button 2121 may be brighter than that of the first home button 2120.

In addition, when the mobile terminal receives an event, the mobile terminal can generate a micro current with a frequency equal to or greater than the predetermined frequency at a boundary of the second virtual home button 2121. Further, the mobile terminal can generate a vibration in the second virtual home button 2121 using a vibration module.

Thus, based on the size or brightness of the displayed virtual home button 2120 or 2121, the user can visually check whether an event is received. Moreover, based on the intensity (frequency) of the micro current, the user can check whether an event is received without watching the display unit.

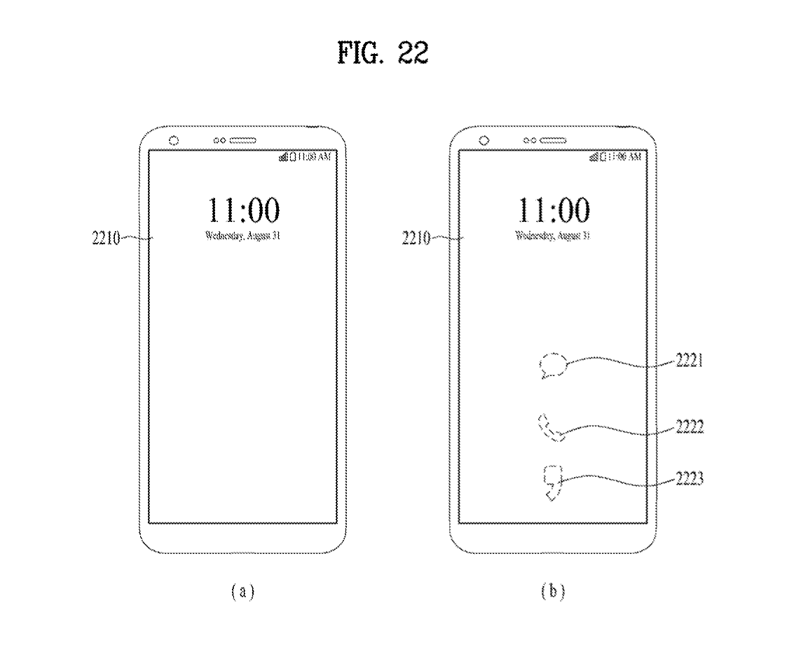

FIG. 22 is a diagram illustrating another example in which the mobile terminal generates a different micro current on the virtual home button based on an event according to one embodiment of the present invention. FIG. 22 (a) shows a virtual home button when no event is received and FIG. 22 (b) shows a virtual home button when an event is received.

Referring to FIG. 22 (a), when no event is received, the mobile terminal can not display a virtual home button while displaying a lock screen 2210. Referring the FIG. 22 (b), when an event is received, the mobile terminal can display a virtual home button 2220 corresponding to the received event. The virtual home button 2220 is not visually displayed.

In more detail, when the mobile terminal receives an event for a message application, the mobile terminal can display a first icon 2221 corresponding to the message application as the virtual home button on the lock screen 2210. The mobile terminal can generate a micro current in at least one of the boundary and inside of the first icon 2221.

In addition, when the mobile receives an event for a call application, the mobile terminal can display a second icon 2222 corresponding to the call application as the virtual home button on the lock screen 2210. The mobile terminal can generate a micro current in at least one of the boundary and inside of the second icon 2222.

Similarly, when the mobile receives an event for the system of the mobile terminal, the mobile terminal can display a third icon 2223 corresponding to the system o as the virtual home button on the lock screen 2210. The mobile terminal can generate a micro current in at least one of the boundary and inside of the third icon 2223.

Although FIG. 22 shows that the first to third icons 2221 to 2223 respectively have predetermined positions, the first to third icons 2221 to 2223 can be displayed at random points. Further, when the mobile terminal senses input signals for selecting the first to third icons 2221 to 2223, the mobile terminal can launch applications respectively corresponding the icons. Therefore, when the mobile terminal receives an event, the user can be aware of the type of the received event through the micro current generated in the display unit.

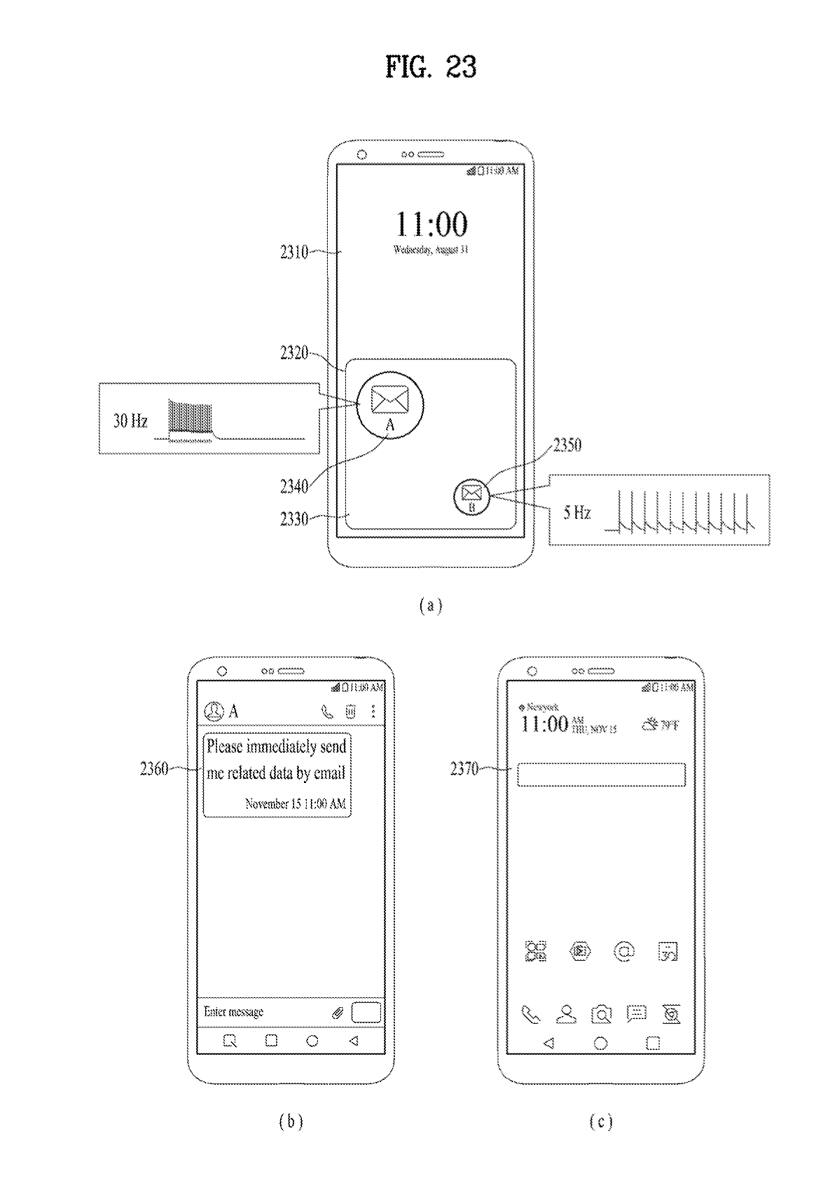

FIG. 23 is a diagram illustrating a further example in which the mobile terminal generates a different micro current on the virtual home button based on an event according to one embodiment of the present invention. According to the embodiment of FIG. 23, the mobile terminal can receive a plurality of events.

Referring to FIG. 23 (a), the mobile terminal can display a virtual home button area 2320 while displaying a lock screen 2310 on the display unit. The virtual home button area 2320 may include a virtual home button 2330, a first icon 2340, and a second icon 2350. The virtual home button 2330 may be an area except the first icon 2340 and the second icon 2350.

In addition, the first icon 2340 may be an icon for a first event and the second icon 2350 may be an icon for a second event. For example, the first event may be a message received through a message application from ‘A’ and the second event may be a message received through the message application from ‘B’.

When determining that the first event is more important than the second event, the mobile terminal can enlarge and display the first icon 2340 such that the first icon 2340 is bigger than the second icon 2350. Referring the aforementioned example, when the ‘A’ who sends the first event is registered in ‘favorites’ and the ‘13’ who sends the second event is not registered in the ‘favorites’, the mobile terminal can determine that the first event is more important than the second event. The mobile terminal can enlarge and display the first icon 2340 such that the first icon 2340 is bigger than the second icon 2350.

In addition, when determining that that the first event is more important than the second event, the mobile terminal can increase the intensity of a micro current of the first icon 2340 such that a frequency of the micro current of the first icon 2340 is higher than that of a micro current of the second icon 2350. Thus, the user can determine which event is more important without watching the display unit.

Referring to FIG. 23 (b), the mobile terminal can sense a first input signal for selecting the first icon 2340. Thereafter, the mobile terminal can launch an application 2360 corresponding to the first icon 2340 based on the first input signal. Referring to the aforementioned example, after sensing the first input signal, the mobile terminal can launch the message application 2360 corresponding to the first icon 2340. The mobile terminal can display the message received through the message application 2360 from the ‘A’.

Referring to FIG. 23 (c), the mobile terminal can sense a second input signal for selecting the virtual home button 2330. The user can select a random point of the virtual home button area 2320 except the first and second icon 2340 and 2350. For example, the user can touch a random area except the first and second icons 2340 and 2350 and then drag the touched area in a random direction. After sensing the second input signal, the mobile terminal can release the lock and then display a home screen 2370.

Moreover, FIGS. 20 to 23 show embodiments of the micro current generated in the virtual home button by the mobile terminal. The mobile terminal can also generate a temperature difference in the virtual home button using a temperature panel disposed on the display unit instead of the micro current.

Referring to the aforementioned example, when the mobile terminal receives an event, the mobile terminal can generate heat such that a temperature of the button is equal to or higher than a predetermined temperature instead of generating a micro current with a frequency equal to or greater than a predetermined frequency in the virtual home button. Thus, the user can not only figure out the location of the virtual home button but also determine whether an event is received without watching the display unit.

Similarly, the aforementioned embodiments can be implemented in an integrated manner. For example, when the mobile terminal receives an event, the mobile terminal can increase the size of the virtual home button, generate the micro current with a frequency equal to or greater than the predetermined frequency, create a vibration in the inside of the virtual home button using the vibration module, generate heat using the temperature panel, or adjust the brightness of the display unit.

Further, although the drawings illustrate that only the virtual home button has different micro currents or temperatures, other buttons for various application may also have different micro currents or temperatures. For example, a ‘photography button’ of the camera application may have different micro currents or temperatures, and a ‘call end button’ of the call application may have different micro currents or temperatures.

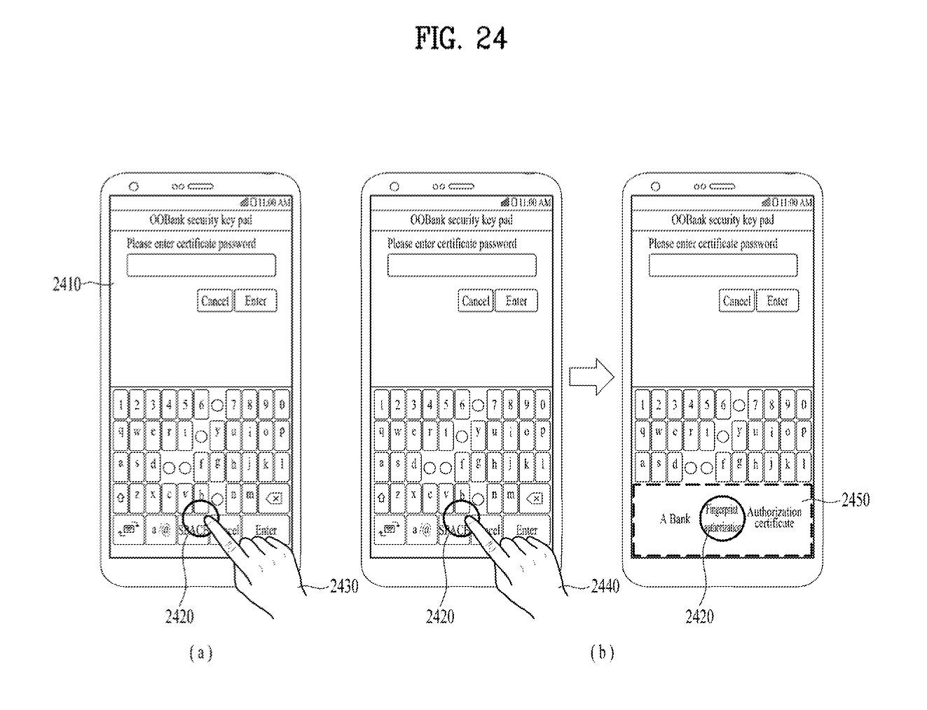

FIG. 24 is a diagram illustrating an example in which the mobile terminal displays information on at least one of the virtual home button and an area for the virtual home button according to one embodiment of the present invention. FIGS. 24 (a) to (c) shows that the mobile terminal displays a content 2410 and a virtual home button 2420 on the display unit. The content 2410 may include various applications. For example, the content 2410 may be an application that requires security information.

Referring to FIG. 24 (a), while display the content 2410, the mobile terminal can sense a first input signal 2430 for selecting the virtual home button 2420. In this case the first input signal 2430 may be in input signal of touching the virtual home button 2420 with first pressure. After sensing the first input signal 2430, the mobile terminal can terminate display of the content 2410 and then display a home screen on the display unit.

Referring to the first drawing of FIG. 24 (b), while display the content 2410, the mobile terminal can sense a second input signal 2440 for selecting the virtual home button 2420. The second input signal 2440 may be an input signal of touching the virtual home button 2420 with second pressure. The second pressure may be different from the first pressure.

Referring to the second drawing of FIG. 24 (b), after sensing the second input signal 2440, the mobile terminal can display information related to the content 2410 on at least one of the virtual home button 2420 or a virtual home button area 2450. In more detail, the mobile terminal can set an area at a predetermined range from the virtual home button 2420 as the virtual home button area 2450. After sensing the second input signal 2440, the mobile terminal can display the information related to the currently displayed content 2410 on at least one of the inside of the virtual home button 2420 and the inside of the virtual home button area 2450.

Referring to the aforementioned example, when the contents 2410 requires the security information, the mobile terminal can authorize a fingerprint through the second input signal for selecting the virtual home button 2420. In addition, after sensing the first input signal 2440, the mobile terminal can display details of the security information on the at least one of the virtual home button 2420 and the virtual home button area 2450.

In more detail, when the mobile terminal senses the second input signal 2440 for selecting the virtual home button 2420 while displaying the content 2410 requiring the security information, the mobile terminal can authorize the fingerprint for the content 2410 from the second input signal 2440 and, at the same time, display the details of the security information on the at least one of the virtual home button 2420 and the virtual home button area 2450.

For example, the mobile terminal can display information indicating that ‘fingerprint authorization’ can be performed through the virtual home button 2420 on the inside of the virtual home button 2420. In addition, the mobile terminal can display not only information on a bank to be authorized but also that the content 2410 requiring the security information is an ‘authorization certificate’ through the virtual home button area 2450.

In addition, when the mobile terminal does not detect an event during a predetermined time while displaying the virtual home button 2420, the mobile terminal can terminate display of the virtual home button 2420. In other words, when the mobile terminal does not detect other input signals while displaying the virtual home button 2420, the mobile terminal can terminate display of the virtual home button 2420. Therefore, the user can use the content 2410 without display of the virtual home button 2420.

Moreover, when the mobile terminal does not detect an event during a predetermined time while displaying the information related to the content 2410 on the at least one of the virtual home button 2420 and the virtual home button area 2450, the mobile terminal can terminate display of the information related to the content 2410 on the at least one of the virtual home button 2420.

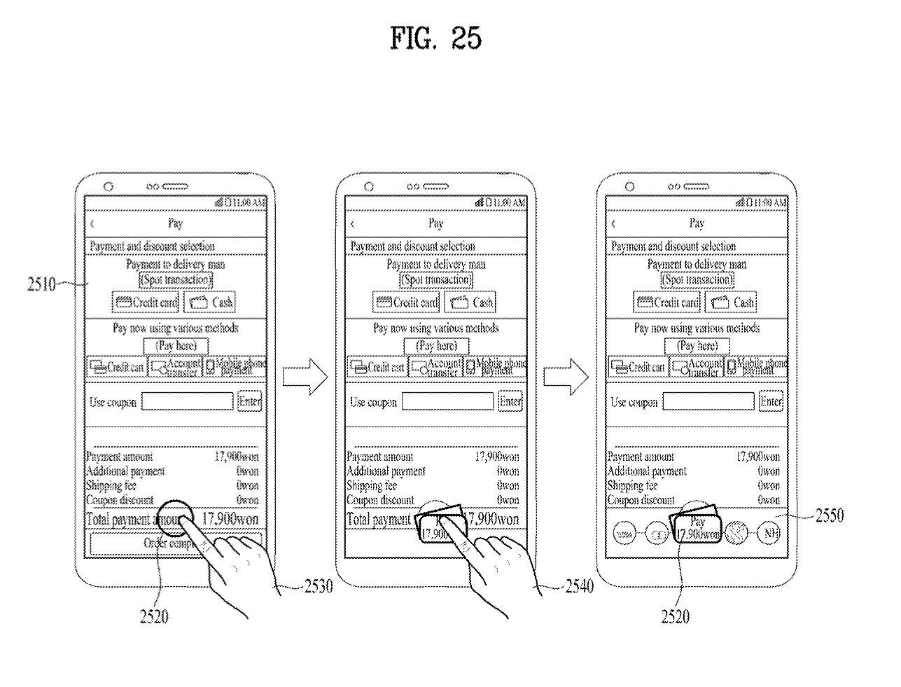

FIG. 25 is a diagram illustrating another example in which the mobile terminal displays information on at least one of the virtual home button and the virtual home button area according to one embodiment of the present invention. Referring to the first to third drawings of FIG. 25, the mobile terminal can display a content 2510 and a virtual home button 2520 on the display unit. The content 2510 may be a payment application unlike FIG. 24.

Referring to the first drawing of FIG. 25, while displaying the content 2510, the mobile terminal can sense a first input signal 2530 for selecting the virtual home button 2520. Referring to the second drawing of FIG. 25, after sensing the first input signal 2530, the mobile terminal can display information related to the content 2510 on the virtual home button 2520. In this instance, depending on the intensity of pressure, the mobile terminal can display a home screen or the information related to the content 2510 on the virtual home button 2520.

In more detail, if the content 2510 displayed on the display unit is the payment application, the mobile terminal can display a payment icon and payment amount on the virtual home button 2520 based on the first input signal 2530. That is, when the user selects the virtual home button 2520, the user can pay the displayed payment amount.

In addition, when the first input signal 2530 has first pressure, the mobile terminal can terminate display of the content 2510 and then display the home screen. Further, when the first input signal has second pressure, the mobile terminal can display the information related to the content 2510 on the virtual home button 2520.

Further, while display the payment icon and payment amount on the virtual home button 2520, the mobile terminal can sense a second input signal 2540 for selecting the virtual home button 2520. The second input signal 2540 may be identical to or different from the first input signal 2530.

Referring to the third drawing of FIG. 25, after sensing the second input signal 2540, the mobile terminal can display information related to the content 2510 on at least one of the virtual home button 2520 and a virtual home button area 2550. In more detail, when the mobile terminal senses the second input signal 2540 while displaying the payment application, the mobile terminal can display the payment icon and payment amount on the virtual home button 2420 and, at the same time, display payment methods on the virtual home button area 2550. For example, the mobile terminal can display a credit card, an account, and mobile terminal information on the virtual home button 2550.

Further, after sensing a third input signal for selecting one of the displayed payment methods, the mobile terminal can pay the payment amount using the selected payment method. The third input signal may be a touch input signal for selecting one of the payment methods. In addition, when the payment methods are displayed based on the second input signal 2540, the third input signal may be an input signal of dragging the touch input to the point at which the desired payment method is displayed and then releasing the touch input at the point.

In addition, the mobile terminal can authorize a fingerprint of the user through at least one of the first input signal 2530, the second input signal 2540, and the third input signal.

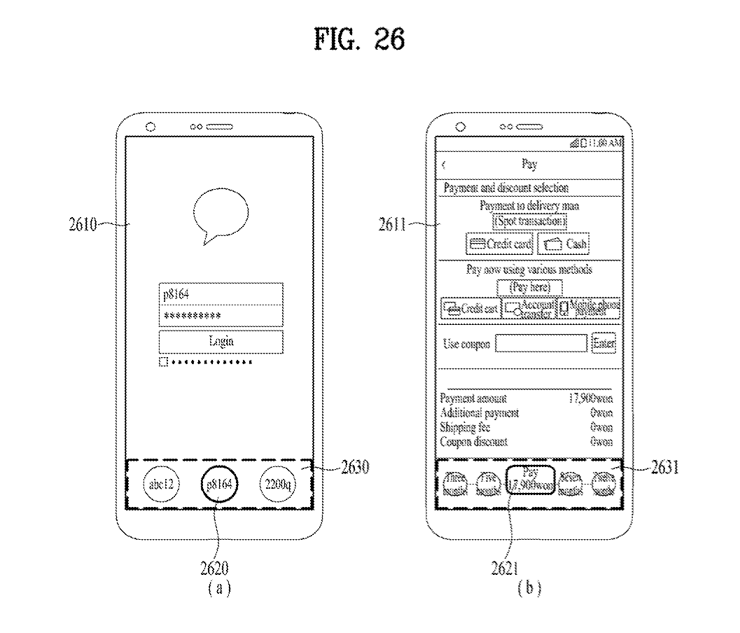

FIG. 26 is a diagram illustrating a further example in which the mobile terminal displays information on at least one of the virtual home button and the virtual home button area according to one embodiment of the present invention. Referring to FIG. 26 (a), while displaying a first content 2610, the mobile terminal can display a first virtual home button 2620. The first content 2610 may be a content that requires login information. For example, the first content 2610 may include a messenger application, a mail application, a web browser, etc.

In addition, the mobile terminal can display information related to the first content 2610 on the first virtual home button 2620. The mobile terminal can change a shape of the first virtual home button 2620 to a login icon. In more detail, if the first content 2610 displayed on the display unit is the content requiring the login information, the mobile terminal can display the login information on the first virtual home button 2620. For example, the mobile terminal can display a login ID for the first content 2610 on the first virtual home button 2620. Therefore, when the user selects the first virtual home button 2620, the user can log in the first content 2610 using the ID displayed on the first home button 2620.

In addition, the mobile terminal can display the information related to the first content 2610 on at least one of the first virtual home button 2620 and a first virtual home button area 2630. In more detail, if the first content 2610 displayed on the display unit is the content requiring the login information, the mobile terminal can display the login information on not only the first virtual home button 2620 but also the first virtual home button area 2630.

For example, the mobile terminal can display a first login ID on the first virtual home button 2620 and second and third login IDs on the first virtual home button area 2630. Further, after sensing an input signal for selecting one of the displayed login IDs, the mobile terminal can log in the first content 2610 using the selected login ID.

Referring to FIG. 26 (b), while display a second content 2611, the mobile terminal can display a second virtual home button 2621. The second content 2611 may be a content that requires payment information. For example, the second content 2611 may correspond to a payment application.

In addition, the mobile terminal can display information related to the second content 2611 on the second virtual home button 2621. The mobile terminal can change a shape of the second virtual home button 2621 into a payment icon.

In more detail, if the second content 2611 displayed on the display unit is the content requiring the payment information, the mobile terminal can display the payment information on the second virtual home button 2621. For example, the mobile terminal can display a payment amount required by the payment application on the second virtual home button 2621. Therefore, when the user selects the second virtual home button 2621, the user can pay the payment amount displayed on the virtual home button 2621.

When the mobile terminal senses an input signal for selecting the second virtual home button 2621 on which the payment amount is displayed, the mobile terminal can pay the payment amount displayed on the payment application. In addition, the mobile terminal can display the information related to the second content 2611 on at least one of the virtual home button 2621 and a second virtual home button area 2631.

In more detail, if the second content 2611 displayed on the display unit is the content requiring the payment information, the mobile terminal can display the payment information on not only the second virtual home button 2621 but also the second virtual home button area 2631. For example, the mobile terminal can display the payment amount on the second virtual home button 2621 and payment periods on the second virtual home button area 2631.

In other words, FIG. 26 (b) may be an embodiment that appears after the payment method is displayed as shown in the third drawing of FIG. 25. In addition, Further, after sensing an input signal for selecting one of the payment periods displayed on the second virtual home button area 2631, the mobile terminal can pay the payment amount displayed on the second virtual home button 2621 according to the selected payment period.

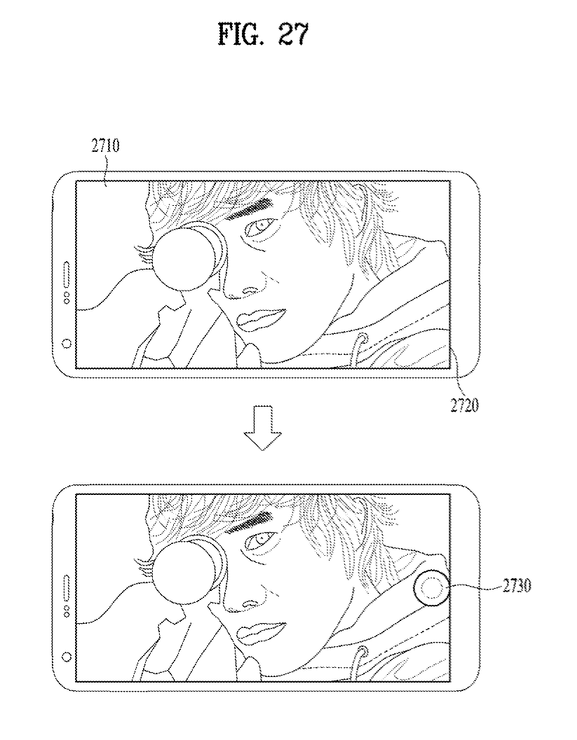

FIG. 27 is a diagram illustrating an example in which the mobile terminal changes the shape of the virtual home button based on a displayed content according to one embodiment of the present invention. Referring to the first drawing of FIG. 27, the mobile terminal can display a content 2710 on the display unit. The content 2710 may be a content that uses a full screen of the display unit. For example, the content 2710 may be a video playback application.

Further, while playing a video, the mobile terminal can sense an input signal of dragging a first side of a bezel part 2720 in a first direction. The bezel part 2720 may mean sides of the display unit of the mobile terminal and in the case of a rectangular mobile terminal, the bezel part 2720 may include four side areas. In this instance, different function may be mapped to the four side areas of the bezel part of the mobile terminal. In addition, the first direction may be a direction from the bezel part 2720 to the center of the display unit.

Referring to the second drawing of FIG. 27, when the mobile terminal senses the input signal of dragging the first side of the bezel part 2720 in the first direction, the mobile terminal can display a first virtual home button 2730 by overlapping it with the played video. The first side of the bezel part 2720 may be a predetermined side.

In more detail, when sensing the input signal of dragging the first side of the bezel part 2720, the mobile terminal can display the first virtual home button 2730. When sensing an input signal of dragging a second side of the bezel part 2720, the mobile terminal can terminate display of the first content 2710. When sensing an input signal of dragging a third side of the bezel part 2720, the mobile terminal can display a control center of the mobile terminal. When sensing an input signal of dragging a fourth side of the bezel part 2720, the mobile terminal can display a notification center of the mobile terminal.

The first virtual home button 2730 may be set to be smaller than a default virtual home button. That is, when playing a video using the full screen of the display unit, the mobile terminal can decrease the size of the virtual home button not to disturb the user from watching the video.

Further, when sensing the input signal of dragging the first side of the bezel part 2720 in the first direction, the mobile terminal can change a color of the first virtual home button 2730 based on the played video. For example, when the video has the black color at the point where the virtual home button 2730 will be displayed, the mobile terminal can change the color of the first virtual home button 2730 to the gray color.

Further, when the video displayed on the display unit has a subject, the mobile terminal can display the first virtual home button 2730 on a first area after sensing the input signal of dragging the first side of the bezel part 2720 in the first direction. The first area may be an area on which the subject is not displayed.

That is, when the mobile terminal displays the content using the full screen of the display unit, the mobile terminal can not display the virtual home button not to disturb the user from watching the content. In addition, when sensing an input signal, the mobile terminal can display the virtual home button in consideration of the color of the displayed content and the subject included in the displayed content.

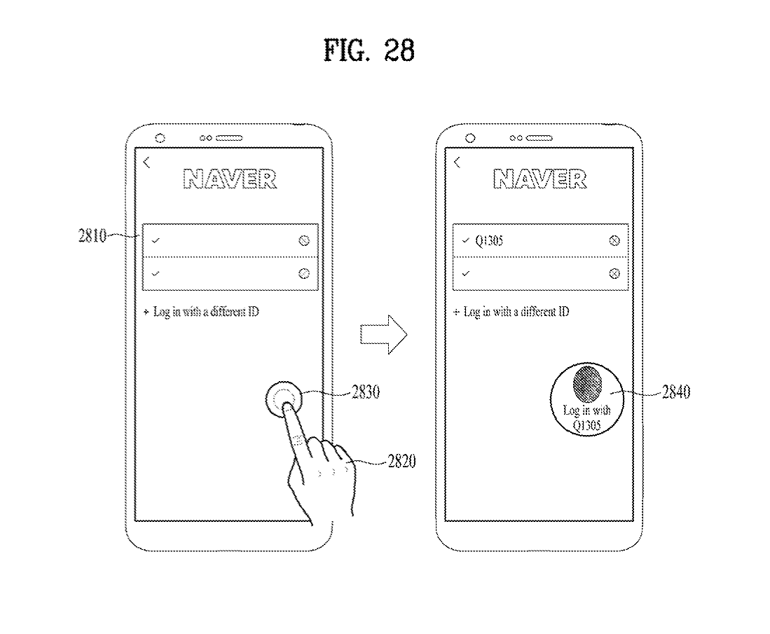

FIG. 28 is a diagram illustrating another example in which the mobile terminal changes the shape of the virtual home button based on a displayed content according to one embodiment of the present invention. Referring to the first drawing of FIG. 28, while displaying a content 2810, the mobile terminal can sense a first input signal 2820. The content 2810 may be a content that requires login information. In addition, the mobile terminal can display a virtual home button 2830 at the point where the first input signal 2820 is sensed.

Referring to the second drawing of FIG. 28, when the mobile terminal senses a second input signal for touching the virtual home button 2830 during a predetermined time or more, the mobile terminal can change a shape of the virtual home button 2830 to a fingerprint form. The second input signal may be an input signal identical to the first input signal 2820. For example, when the user touches a random pint of the content 2810, the mobile terminal can display the virtual home button 2830. In addition, the user touches the virtual home button 2830 during the predetermined time or more, the mobile terminal can change the shape of the virtual home button 2830 to the fingerprint form.

In addition, the second input signal may be an input signal different from the first input signal 2830. For example, when the user touches a random pint of the content 2810, the mobile terminal can display the virtual home button 2830. In addition, when the user touches the displayed virtual home button 2830 with predetermined pressure, the mobile terminal can change the shape of the virtual home button 2830 to the fingerprint form.

Thus, the user can recognize that the user needs to input a fingerprint through the virtual home button 2830, the shape of which is changed to the fingerprint form, in order to log in the content 2810. After sensing the second input signal, the mobile terminal can display a login ID 2840 in the virtual home button. Thus, when the user logs in using the virtual home button 2830, the user can log in the content 2810 using the login ID displayed on the virtual home button 2830.

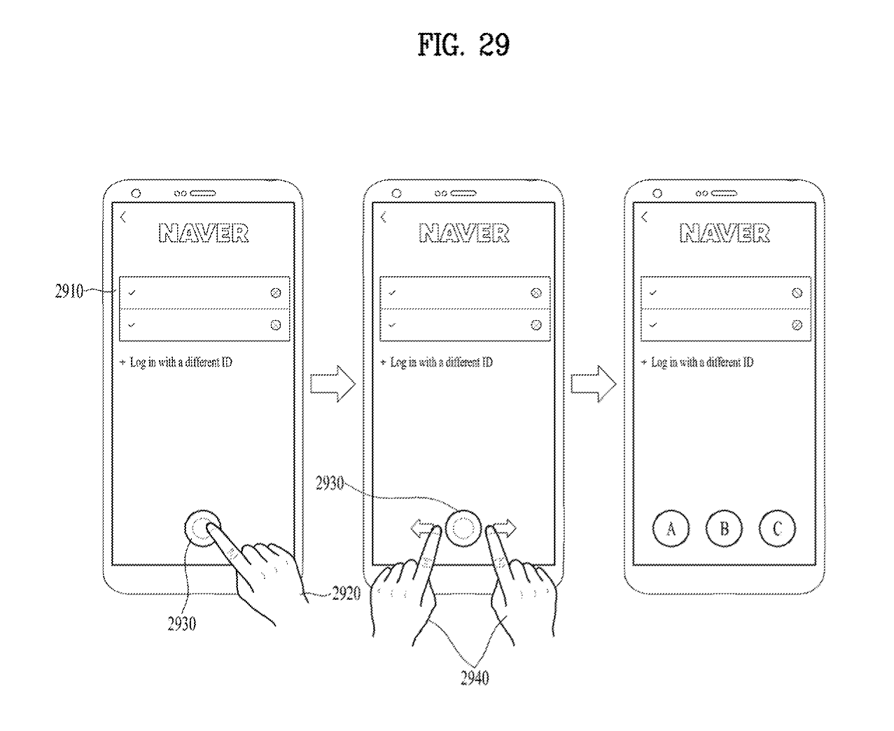

FIG. 29 is a diagram illustrating an example in which the mobile terminal changes the shape of the virtual home button based on an input signal according to one embodiment of the present invention. Referring to the first drawing of FIG. 29, while displaying a content 2910, the mobile terminal can sense a first input signal 2920. The content 2910 may include various applications. After sensing the first input signal 2920, the mobile terminal can display a virtual home button 2930 at the point where the first input signal 2920 is sensed. The first input signal 2920 may be a touch input signal with predetermined pressure. In addition, unlike the aforementioned embodiments, even if the mobile terminal does not detect the first input signal 2920, the mobile terminal can display the virtual home button 2930.

Referring to the second drawing of FIG. 29, the mobile terminal can sense a second input signal 2940 for selecting the displayed virtual home button 2930. The second input signal 2940 may be an input signal of multi-touching the virtual home button 2930. For example, the user can touch the displayed virtual home button 2930 with two fingers and then drag the two fingers in different direction. That is, as shown in the second drawing of FIG. 29, the user can multi-touch the virtual home button 2930 with the two fingers and then drag the two fingers in opposite directions.

Referring to third drawing of FIG. 29, the mobile terminal can divide the virtual home button into a plurality of buttons based on the second input signal 2940. In addition, the mobile terminal can map different functions to a plurality of the buttons divided from the virtual home button 2930. For example, the mobile terminal can divide the virtual home button 2930 into a back key, a home key, and a recent key.

In addition, the mobile terminal can determine functions of a plurality of the divided buttons based on the displayed content 2910. For example, if the displayed content 2910 is a video playback application, the mobile terminal can divide the virtual home button 2930 into a rewind button, a fast-forward button, and a pause button.

In addition, the display unit of the mobile terminal can include a front surface part and an edge part. The front surface part may mean a plane area corresponding to the center area of the display unit and the edge part may mean a curved area corresponding to side areas of the display unit except the front surface part. Hereinafter, embodiments of displaying a virtual home button and an unlock pattern will be described by assuming that the display unit of the mobile terminal includes the front surface part and edge part.

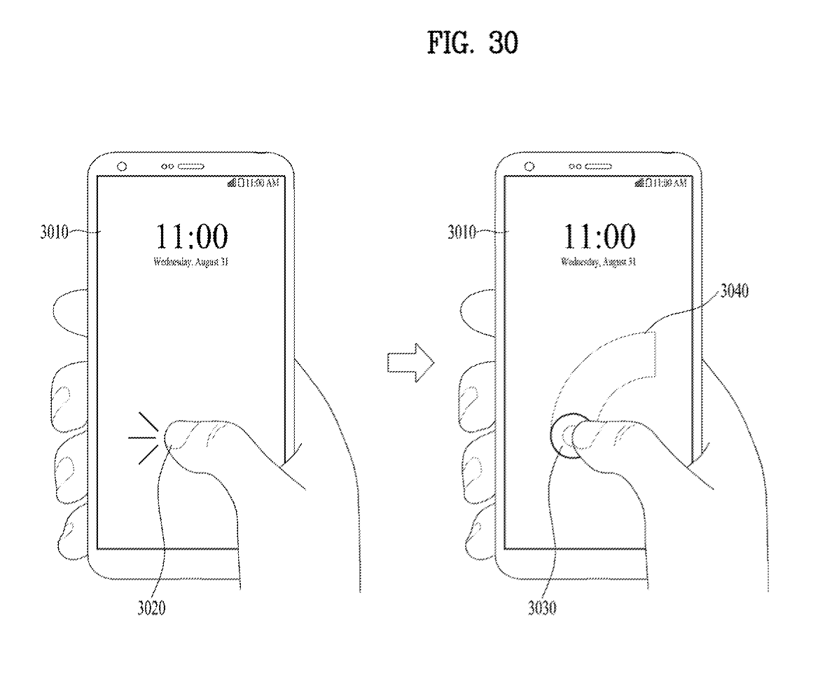

FIG. 30 is a diagram illustrating an example in which the mobile terminal displays an unlock pattern according to one embodiment of the present invention. Referring to the first drawing of FIG. 30, the mobile terminal can display a lock screen 3010 on the display unit.

In addition, the mobile terminal can sense a first input signal 3020 of touch a random point on the lock screen 3010. The first input signal 3020 may be a touch input signal with predetermined pressure. That is, to prevent a virtual home button 3030 and an unlock pattern 3040 from being displayed when the user touches the random point on the lock screen 3010, the virtual home button 3030 and the unlock pattern 3040 can be configured to be displayed only when the user touches the mobile terminal with the predetermined pressure.

Referring to the second drawing of FIG. 30, the mobile terminal can display the virtual home button 3030 and the unlock pattern 3040 based on the first input signal 3020. The unlock pattern 3040 may be a pattern of moving the virtual home button 3030 to unlock the mobile terminal.

In more detail, the mobile terminal can display the virtual home button 3030 at the point where the first input signal 3020 is sensed. In addition, when sensing the first input signal 3020, the mobile terminal can detect a grip state of the mobile terminal. Referring to the embodiment of FIG. 30, when sensing the first input signal 3020, the mobile terminal can detect that the user grips the mobile terminal with the right hand and inputs the first input signal 3020 using the right thumb.

In addition, the mobile terminal can display the unlock pattern 3040 based on the point where the first input signal 3020 is sensed and the grip state of the mobile terminal. The unlock pattern 3040 may be connected to the virtual home button 3030. For example, when the user grips the mobile terminal with the right hand, the mobile terminal can display the fan-shaped unlock pattern 3040 in the right direction.

Further, the mobile terminal can recognize a fingerprint through the first input signal 3020 for selecting the virtual home button 3030. Thus, only when the fingerprint recognized through the first input signal 3020 matches a registered fingerprint, the mobile terminal can display the unlock pattern 3040.

Further, when the mobile terminal displays the virtual home button 3030 and the unlock pattern 3040 and senses an input signal for moving the virtual home button 3030 according to the unlock pattern 3040, the mobile terminal can be unlocked. That is, when the user touches the virtual home button and then drags the touch in the direction of the unlock pattern 3040, the user can unlock the mobile terminal.

In other words, instead of displaying an unlock pattern with a fixed direction and length, the mobile terminal can display the unlock pattern in consideration of the touch input point from the user and the grip state of the mobile terminal.

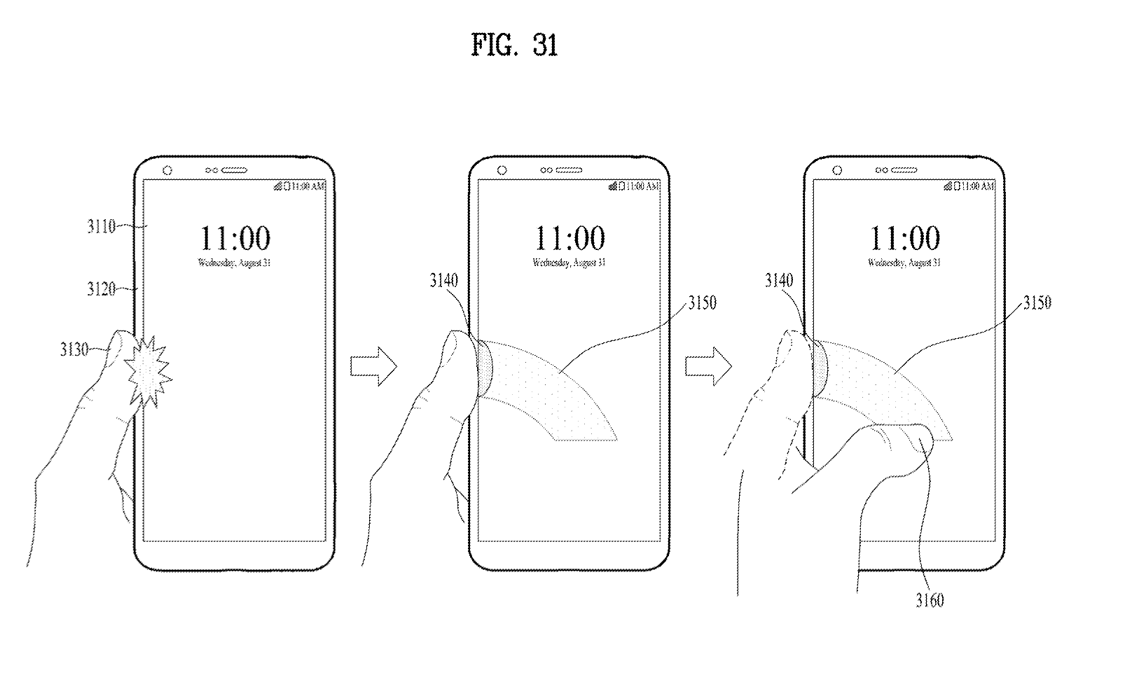

FIG. 31 is a diagram illustrating another example in which the mobile terminal displays the unlock pattern according to one embodiment of the present invention. Unlike FIG. 30, FIG. 31 shows an example of sensing a first input signal 3130 of touching a random point of an edge part 3120 of the display unit of the mobile terminal. For clarity, the virtual home button 3030 and the unlock pattern 3040 of FIG. 30 are referred to as a first virtual home button and a first unlock pattern.

Referring to the first drawing of FIG. 31, while displaying a lock screen 3110 on the display unit, the mobile terminal can sense a first input signal 3130 of touching the edge part 3120. The user can touch the edge part 3120 of the mobile terminal with first pressure using the left thumb while gripping the mobile terminal with the left hand Referring to the second drawing of FIG. 31, after sensing the first input signal 3130, the mobile terminal can display a second virtual home button 3140 and a second unlock pattern 3150 on the lock screen 3110.

In more detail, the mobile terminal can display the second virtual home button 3140 at the point where the first input signal 3130 is sensed. In addition, when sensing the first input signal 3130, the mobile terminal can detect a grip state of the mobile terminal. Referring to the embodiment of FIG. 31, when sensing the first input signal 3130, the mobile terminal can detect that the user grips the mobile terminal with the left hand and touches the edge part 3120 with the first pressure using the left thumb.

In addition, the mobile terminal can display the second unlock pattern 3150 based on the point where the first input signal 3130 is sensed and the grip state of the mobile terminal. The second unlock pattern 3150 may be connected to the second virtual home button 3140.

In addition, the length the second unlock pattern 3150 may be shorter than that of the first unlock pattern. That is, considering that a movement range of the user's left thumb is decreased because the second virtual home button 3140 is displayed on the edge part 3120, the mobile terminal can set the length of the second unlock pattern 3150 to be shorted than that of the first unlock pattern.

Referring to the third drawing of FIG. 31, after sensing a second input signal 3160 for moving the second virtual home button 3140 in the direction of the second unlock pattern 3150, the mobile terminal can be unlocked.

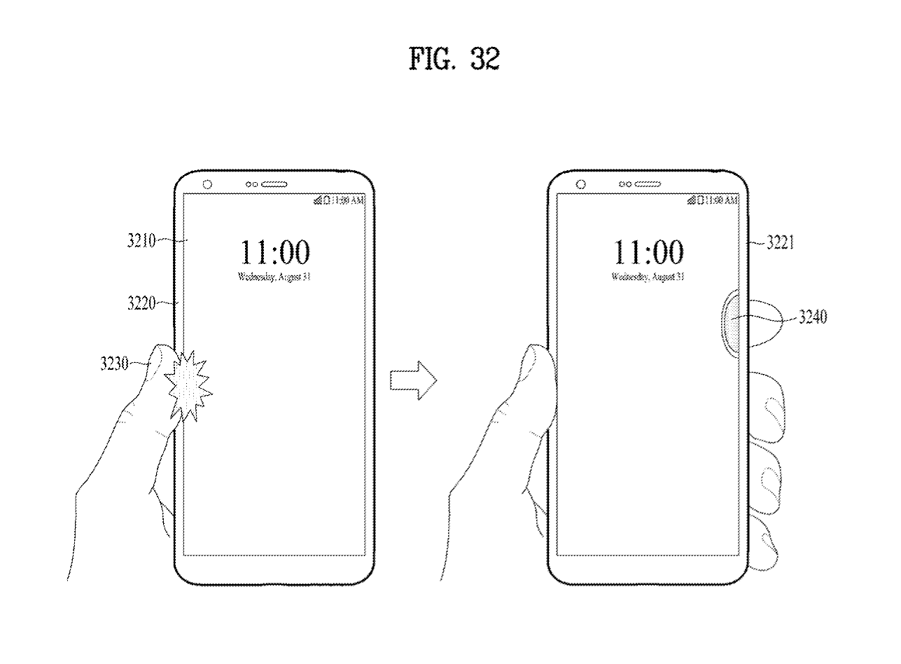

FIG. 32 is a diagram illustrating an example in which the mobile terminal does not display an unlock pattern according to one embodiment of the present invention. Referring to the first drawing of FIG. 32, while displaying a lock screen 3210 on the display unit, the mobile terminal can sense a first input signal of touching an edge part 3220. For example, while gripping the mobile terminal with the left hand, the user can touch the edge part 3220 of the mobile terminal with first pressure using the left thumb.

In addition, the mobile terminal can determine whether a fingerprint recognized through the first input signal 3230 matches a registered fingerprint. When the fingerprint recognized through the first input signal 3230 matches the registered fingerprint, the mobile terminal can display an unlock pattern as shown in the embodiment of FIG. 31. In the embodiment of FIG. 32, it is assumed that the fingerprint recognized through the first input signal 3230 does not match the registered fingerprint.

Referring to the second drawing of FIG. 32, when the fingerprint recognized through the first input signal 3230 does not match the registered fingerprint, the mobile terminal can display a virtual home button 3240 at a first point rather than the point where the first input signal 3230 is sensed. The first point may be a point where the registered fingerprint is expected to exist.

In more detail, the mobile terminal can detect a grip state of the mobile terminal through the first input signal 3230. The mobile terminal can detect not only a location of the finger used to input the first input signal 3230 but also locations of the remaining fingers used to grip the mobile terminal

Referring to the aforementioned example, the mobile terminal can detect that the user touches the left side of the edge part 3220 using the left thumb while gripping the mobile terminal with the left hand. Thus, the mobile terminal can detect that the remaining fingers of the left hand are sequentially placed at the right side of the edge part 3221.

If the mobile terminal determines that the fingerprint of the left index finger matches the registered fingerprint, the mobile terminal can display the virtual home button 3240 at the first point where the left index finger is placed. That is, when the user attempts to authorize the fingerprint using other fingerprints except the registered fingerprint, the mobile terminal can lead the authorization of the registered fingerprint by displaying the virtual home button 3240 at the point where the registered fingerprint is expected to exist.

In addition, to distinguish between the case in which the registered fingerprint is recognized and the case in which a non-registered fingerprint is recognized, a color of the virtual home button may be changed.

Moreover, the mobile terminal can authorize a recognized fingerprint based on an input signal of touching the edge part or the front surface part.

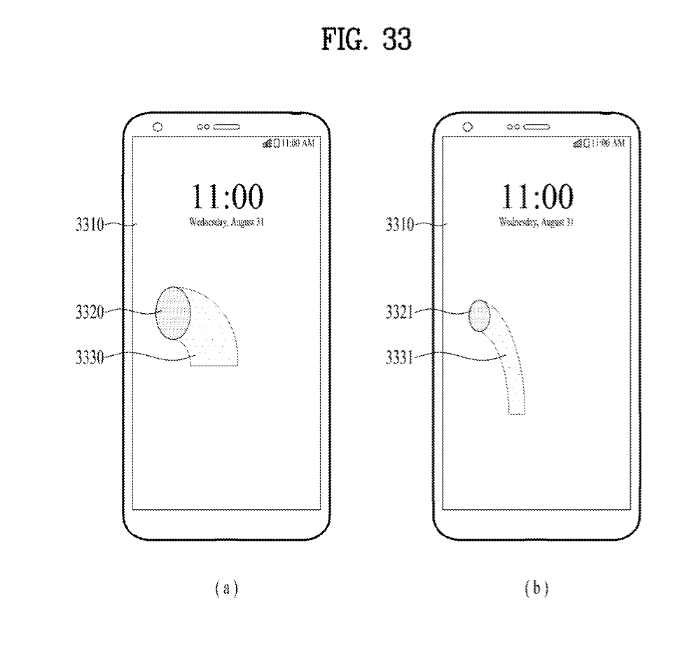

FIG. 33 is a diagram illustrating an example in which the mobile terminal displays the unlock pattern based on an inclination of the mobile terminal according to one embodiment of the present invention. FIG. 33 (a) shows an embodiment of displaying an unlock pattern when the mobile terminal is placed horizontally with respect to the floor and FIG. 33 (b) shows an embodiment of displaying an unlock pattern when the mobile terminal is placed vertically with respect to the floor.

Referring to FIG. 33 (a), the mobile terminal can display a first virtual home button 3320 and a first unlock pattern 3330 on a lock screen 3310. The first virtual home button 3320 and the first unlock pattern 3330 may be displayed based on an input signal as described above. Alternatively, the first virtual home button 3320 and the first unlock pattern 3330 may be displayed without an input signal.

In addition, the mobile terminal can detect an inclination of the mobile terminal. When the mobile terminal detects that the inclination of the mobile terminal is almost horizontal with respect to the floor, the mobile terminal can enlarge the first virtual home button 3320 such that the first virtual home button 3320 is bigger than a predetermined value, decrease the length of the first unlock pattern 3330 such that the length of the first unlock pattern 3330 is shorter than a predetermined value, and increase the thickness of the first unlock pattern 3330 such that the thickness of the first unlock pattern 3330 is greater than a predetermined value.

If the user walks along a street while gripping the mobile terminal with a hand, the mobile terminal can be almost horizontal with respect to the floor. The user needs to unlock the mobile terminal while walking along the street and gripping the mobile terminal with the hand. That is, since the user should unlock the mobile terminal while moving, the mobile terminal can enlarge the first virtual home button 3320, decrease the length of the first unlock pattern 3330 by which the first virtual home button 3320 should move, and increase the thickness of the first unlock pattern 3330 in order to allow the user to easily unlock the mobile terminal.

Referring to FIG. 33 (b), the mobile terminal can display a second virtual home button 3321 and a second unlock pattern 3331. The mobile terminal can also detect the inclination of the mobile terminal.

When the mobile terminal detects that the inclination of the mobile terminal is almost vertical with respect to the floor, the mobile terminal can reduce the second virtual home button 3321 such that the second virtual home button 3321 is smaller than the predetermined value, increase the length of the second unlock pattern 3331 such that the length of the second unlock pattern 3331 is longer than the predetermined value, and decrease the thickness of the second unlock pattern 3331 such that the thickness of the first unlock pattern 3331 is smaller than the predetermined value.

Referring to the aforementioned embodiment, when the mobile terminal detects that the inclination of the mobile terminal is closer to the vertical plane than the horizontal plane, the mobile terminal can reduce the size of the second virtual home button 3321 such that the second virtual home button 3321 is smaller than the first virtual home button 3320, increase the length of the second unlock pattern 3331 such that the length of the second unlock pattern 3331 is longer than that of the first unlock pattern 3330, and decrease the thickness of the second unlock pattern 3331 such that the thickness of the second unlock pattern 3331 is smaller than that of the first unlock pattern 3330.

When the user connects the mobile terminal to the cradle or uses the mobile terminal at a chair, the mobile terminal can be almost vertical with respect to the floor. In this instance, since the user unlocks the mobile terminal in a fixed state, the mobile terminal needs to prevent malfunction.

Thus, the mobile terminal can reduce the size of the second virtual home button 3321, increase the length of the second unlock pattern 3331 by which the second virtual home button 3321 should move, and decrease the thickness of the second unlock pattern 3321 to make the unlock of the mobile terminal difficult.

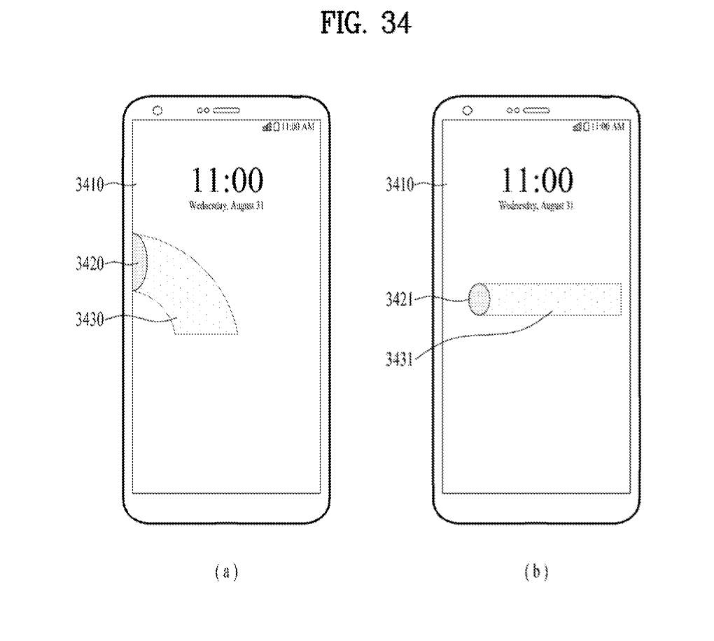

FIG. 34 is a diagram illustrating an example in which the mobile terminal displays an unlock pattern based on an input signal according to one embodiment of the present invention. FIG. 34 (a) shows an embodiment of displaying an unlock pattern when the mobile terminal senses an input signal through the edge part and FIG. 34 (b) shows an embodiment of displaying an unlock pattern when the mobile terminal senses an input signal through the front surface part.

Referring to FIG. 34 (a), the mobile terminal can sense a first input signal of touching the edge part with first pressure. After sensing the first input signal, the mobile terminal can display a first virtual home button 3420 and a first unlock pattern 3430.

The mobile terminal can display the first virtual home button 3420 and the first unlock pattern 3430 based on the point where the first input signal is sensed. That is, when the mobile terminal senses the first input signal through a first side of the edge part, the mobile terminal can display the first virtual home button 3420 at the point where the first input signal is sensed.

In addition, when the mobile terminal senses the first input signal through the first side of the edge part, the mobile terminal can reduce the length of the first unlock pattern 3430 such that the length of the first unlock pattern 3430 is shorter than a predetermined length. In addition, when the mobile terminal senses the first input signal through the first side of the edge part, the mobile terminal can display the first unlock pattern 3430 in the form of a fan in consideration of a movement of the user's thumb.

Referring to FIG. 34 (b), the mobile terminal can sense a second input signal of touching the front surface part with the first pressure. After sensing the second input signal, the mobile terminal can display a second virtual home button 3421 and a second unlock pattern 3431.

The mobile terminal can display the second virtual home button 3421 and the second unlock pattern 3431 based on the point where the second input signal is sensed. That is, when the mobile terminal senses the second input signal through a first point of the front surface part of the mobile terminal, the mobile terminal can display the second virtual home button 3420 at the point where the second input signal is sensed.

In addition, when the mobile terminal senses the second input signal through the first point of the front surface part of the mobile terminal, the mobile terminal can increase the length of the second unlock pattern 3431 such that the length of the second unlock pattern 3431 is longer than the predetermined length. For example, the mobile terminal can increase the length of the second unlock pattern 3431 such that the length of the second unlock pattern 3431 is longer than that of the first unlock pattern 3430.

Moreover, when the mobile terminal senses the second input signal through the first point of the front surface part, the mobile terminal can display the second unlock pattern 3431 in the form of a rectangle in consideration of a movement of the finger used to touch the mobile terminal. That is, in consideration of movements of the user's finger, the mobile terminal can set the virtual home button and unlock pattern when the user intends to unlock the mobile terminal by selecting the edge part to be different from those when the user intends to unlock the mobile terminal by selecting the front surface part.

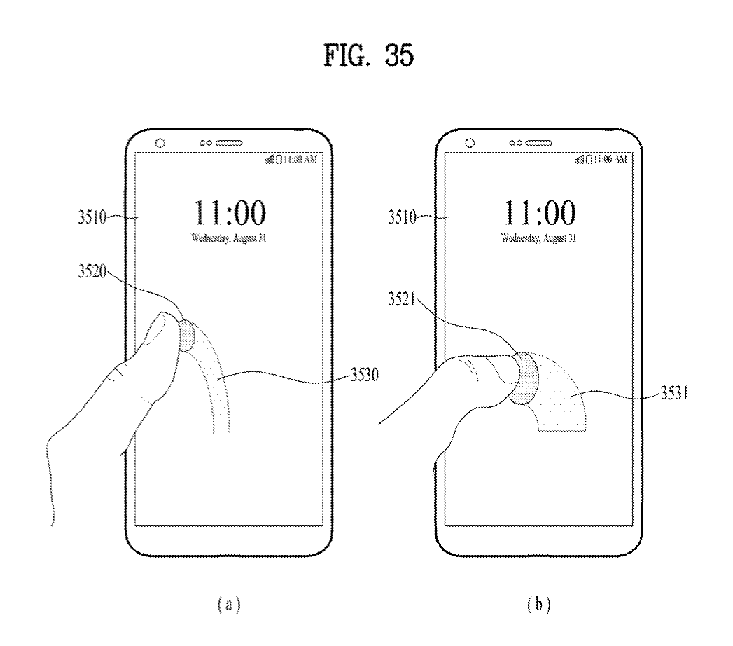

FIG. 35 is a diagram illustrating another example in which the mobile terminal displays an unlock pattern based on an input signal according to one embodiment of the present invention. FIG. 35 (a) shows an embodiment of displaying an unlock pattern when the mobile terminal senses a small or narrow finger and FIG. 35 (b) shows an embodiment of displaying an unlock pattern when the mobile terminal senses a great or wide finger.

Referring to FIG. 35 (a), after sensing a first input signal, the mobile terminal can display a first virtual home button 3520 and a first unlock pattern 3530 on a lock screen 3510 In more detail, the mobile terminal can display the first virtual home button 3520 and the first unlock pattern 3530 based on the point or area where the first input signal is sensed. The first virtual home button 3520 may be displayed at the point where the first input signal is sensed. For example, Further, when the first input signal is sensed through the first side of the edge part, the mobile terminal can display the first virtual home button 3520 on the first side of the edge part.

In addition, FIG. 35 (a) shows a case in which the area where the first input signal is small or narrow. In this embodiment, the mobile terminal can increase the length of the first unlock pattern 3530 and decrease the thickness of the first unlock pattern 3530. For example, if the user touches the lock screen 3510 using a part of the index or little finger, the mobile terminal can display the first unlock pattern 3530.

Referring to FIG. 35 (b), after sensing a second input signal, the mobile terminal can display a second virtual home button 3521 and a second unlock pattern 3531 on the lock screen 3510. In more detail, the mobile terminal can display the second virtual home button 3521 and the second unlock pattern 3531 based on the point or area where the second input signal is sensed. The second virtual home button 3521 may be displayed at the point where the second input signal is sensed.

In addition, FIG. 35 (b) shows a case in which the area where the second input signal is large or wide. In this embodiment, the mobile terminal can decrease the length of the second unlock pattern 3531 and increase the thickness of the second unlock pattern 3531. For example, if the user touches the lock screen 3510 using the entirety of the thumb, the mobile terminal can display the second unlock pattern 3531. That is, the mobile terminal can display different virtual home buttons and unlock patterns depending on which finger the user uses and which direction the input signal is touched in.

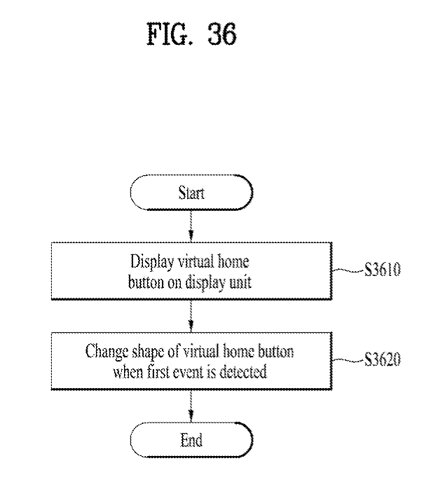

FIG. 36 is a diagram illustrating an example in which the mobile terminal changes the virtual home button based on an event according to one embodiment of the present invention. Each step of FIG. 36 can be controlled by the controller of FIG. 1A. In a step S3610, after sensing a first input signal through the sensing unit, the mobile terminal can display a virtual home button on the display unit.

In addition, the first input signal can be sensed by a front surface part or an edge part of the display unit. Thus, the mobile terminal can display the virtual home button at a point where the first input signal is sensed. In addition, In addition, the mobile terminal can recognize a fingerprint through the virtual home button. When the recognized fingerprint matches a registered fingerprint, the mobile terminal can be unlocked.

In a step s3620, after detecting a first event, the mobile terminal can change a shape of the virtual home button. In addition, the first event may include a movement of the mobile terminal. Thus, the mobile terminal can change the shape of the virtual home button based on the movement of the mobile terminal.

In addition, the first event may include a notification received by the mobile terminal from an external device. Thus, the mobile terminal can display a notification icon on a guide area at a predetermined range from the virtual home button based on the received notification

Moreover, the first event may include an inclination of the mobile terminal. Thus, the mobile terminal can change a shape and location of the virtual home button based on the inclination of the mobile terminal.

Further, it is apparent that the embodiments described with reference to FIGS. 5 to 35 can be implemented as the controlling method for the mobile terminal described with reference to FIG. 36

The present invention mentioned in the foregoing description can be implemented in a program recorded medium as computer-readable codes. The computer-readable media may include all kinds of recording devices in which data readable by a computer system are stored. The computer-readable media may include HDD (Hard Disk Drive), SSD (Solid State Disk), SDD (Silicon Disk Drive), ROM, RAM, CD-ROM, magnetic tapes, floppy disks, optical data storage devices, and the like for example and also include carrier-wave type implementations (e.g., transmission via Internet). Further, the computer may include the controller 180 of the terminal. Thus, the above embodiments are to be considered in all respects as illustrative and not restrictive. The scope of the invention should be determined by reasonable interpretation of the appended claims and all change which comes within the equivalent scope of the invention are included in the scope of the invention.

What is claimed is:

1. A mobile terminal comprising:
a touch screen; and
a processor configured to:
display a virtual home button on the touch screen, and
change a shape of the virtual home button to represent a first event on the mobile terminal.

2. The mobile terminal of claim 1, wherein the processor is configured to display the virtual home button in response to a first input signal.

3. The mobile terminal of claim 1, wherein the processor is configured to:
display a lock screen on the touch screen,
detect a movement of the mobile terminal,
when the movement is greater than a predetermined value, decrease a size of the virtual home button on the touch screen, and
when the movement is smaller than the predetermined value, increase the size of the virtual home button on the touch screen.

4. The mobile terminal of claim 1, wherein when the first event is not detected during a predetermined time, the processor is configured to either increase a size of the virtual home button on the touch screen or terminate display of the virtual home button.

5. The mobile terminal of claim 1, wherein the processor is configured to display an area at a predetermined range from the virtual home button as a guide area.

6. The mobile terminal of claim 5, further comprising:
a wireless communication unit configured to transmit and receive events to and from an external device,
wherein when a second event is received through the wireless communication unit, the processor is configured to display a notification icon corresponding to the second event on the guide area.

7. The mobile terminal of claim 6, wherein when an input signal for moving the virtual home button to a location of the notification icon is sensed, the processor is configured to launch an application corresponding to the second event.

8. The mobile terminal of claim 5, wherein the processor is configured to sequentially display thumbnails corresponding to one or more background applications on the guide area.

9. The mobile terminal of claim 8, wherein when a select input signal for selecting the virtual home button is sensed while a first thumbnail is displayed on the guide area, the processor is configured to launch an application corresponding to the first thumbnail.

10. The mobile terminal of claim 2, further comprising:
a fingerprint recognition sensor,
wherein the processor is configured to:
display the virtual home button at a point where the first input signal is sensed, and
when a fingerprint is authorized using the virtual home button, unlock the mobile terminal.

11. The mobile terminal of claim 10, wherein the virtual home button comprises one or more buttons to which functions are mapped.

12. The mobile terminal of claim 1, wherein the processor is configured to:
display a first content on the touch screen,
set an area at a predetermined range from the virtual home button as a virtual home button area, and
display information related to the first content on at least one of the virtual home button and the virtual home button area.

13. The mobile terminal of claim 12, further comprising:
a fingerprint recognition sensor,
wherein the processor is configured to:
when the first content requires security information, authorize a fingerprint using the virtual home button, and
display details of the security information on the at least one of the virtual home button and the virtual home button area.

14. The mobile terminal of claim 1, wherein the processor is configured to:
when a video is played on the touch screen, the processor is configured to decrease a size of the virtual home button to be smaller than a predetermined value.

15. The mobile terminal of claim 1, wherein when a video is played on the touch screen, the processor is configured to change a color of the virtual home button based on a color of the played video.

16. The mobile terminal of claim 1, wherein when a video including a subject is played on the touch screen, the processor is configured to display the virtual home button on a first area of the touch screen, and
wherein the first area is an area on which the subject is not displayed.

17. The mobile terminal of claim 1, wherein when a multi-touch input signal for selecting the virtual home button is sensed, the processor is configured to divide the virtual home button into a plurality of buttons.

18. The mobile terminal of claim 1, wherein the touch screen includes a front surface part and an edge part, and
wherein the processor is configured to:
sense a selection input signal for selecting one of the front surface part and the edge part,
determine an unlock pattern based on at least one of a point where the selection input signal is sensed, an inclination of the mobile terminal, and a grip state of the mobile terminal, and
display the determined unlock pattern on the touch screen.

19. The mobile terminal of claim 18, further comprising:
a fingerprint recognition sensor,
wherein the processor is configured to:
authorize a fingerprint input at a point where the selection input signal is sensed,
when the fingerprint matches a registered fingerprint, display the unlock pattern, and
when the fingerprint does not match the registered fingerprint, display the virtual home button at a point different from that where the seventh input signal is sensed.

20. A method of controlling a mobile terminal, the method comprising:
displaying a virtual home button on a touch screen of the mobile terminal; and
changing, via a controller of the mobile terminal, a shape of the virtual home button to represent a first event on the mobile terminal.
